(19) United States
(12) Patent Application Publication
(10) Pub. No.: US 2025/0385472 A1
(43) Pub. Date: Dec. 18, 2025

(54) ELECTRICAL CONNECTOR

(71) Applicant: HIROSE ELECTRIC CO., LTD., Kanagawa (JP)

(72) Inventors: Yohei HASEGAWA, Kanagawa (JP); Hikaru IWAI, Kanagawa (JP)

(21) Appl. No.: 19/235,791

(22) Filed: Jun. 12, 2025

(30) Foreign Application Priority Data
Jun. 14, 2024 (JP) 2024-096522

(51) Int. Cl. H01R 13/6471; H01R 12/71

(52) U.S. Cl. CPC H01R 13/6471; H01R 12/716

(57) ABSTRACT

An electrical connector has a plurality of signal terminals arranged parallel to a surface of a plate and a housing that retains the plurality of signal terminals. The plurality of signal terminals includes a signal terminal pair having a pair of signal terminals adjacent to each other. The signal terminals of the signal terminal pair have an exposed portion. The exposed portion has a projection and a recess, a wide width portion formed in a range corresponding to the projection, and a narrow width portion formed in a range corresponding to the recess, and the narrow width portion has a terminal width narrower than that of the wide width portion. The wide width portions and the narrow width portions of the exposed portion in the signal terminal pair are formed at same positions in the extending direction.

### CROSS-REFERENCE TO RELATED APPLICATION

This application is based on Japanese Patent Application No. 2024-096522 filed with the Japan Patent Office on Jun. 14, 2024, the entire content of which is hereby incorporated by reference.

### BACKGROUND

### 1. Technical Field

An aspect of the present disclosure relates to an electrical connector.

### 2. Related Art

JP-A-2023-178890 discloses an electrical connector disposed on the mounting surface of a circuit board. This electrical connector has a fixing housing, a movable housing that is relatively movable with respect to the fixing housing, and a plurality of terminals provided over both the fixing housing and the movable housing. The plurality of terminals is a so-called bent terminal produced by bending a metal band-shaped piece in a plate thickness direction. These terminals are arranged in one direction parallel to the mounting surface, which is a terminal arrangement direction. The terminals have a middle portion exposed between the fixing housing and the movable housing. This middle portion is elastically displaced, and thus, the movement of the movable member is permitted. The middle portion has a bent portion located at both ends and a straight portion that couples the bent portions to each other.

These terminals include a signal terminal pair, including a pair of signal terminals adjacent to each other, and the signal terminal pair can transmit differential signals. In the signal terminals, the straight portion is thicker than the bent portion. That is, the terminal width dimension (the dimension in the terminal arrangement direction) of the straight portion is greater than the terminal width dimension of the bent portion. Generally, when a part of the terminal is exposed to the air, the impedance of the exposed part easily becomes excessively high. In JP-A-2023-178890, thickening the straight portion exposed to the air suppresses an increase in the impedance at the straight portion.

### SUMMARY

An electrical connector according to the present embodiment includes: a plurality of signal terminals having a shape where a metal plate member is bent in a plate thickness direction, in which the plurality of signal terminals are arranged as one direction parallel to a surface of a plate is an arrangement direction; and a housing that retains the plurality of signal terminals. In the electrical connector, a direction at a right angle with respect to the arrangement direction is a fitting direction that is a direction of fitting and connecting a counterpart connector, the plurality of signal terminals includes a signal terminal pair having a pair of signal terminals adjacent to each other, and a differential signal is transmissible by the signal terminal pair, the signal terminals of the signal terminal pair have an exposed portion exposed and extending from the housing, the exposed portion has a projection and a recess formed on both side edges of the exposed portion extending in an extending direction, a wide width portion formed in a range corresponding to the projection, and a narrow width portion formed in a range corresponding to the recess, the narrow width portion having a terminal width narrower than that of the wide width portion, and the wide width portions and the narrow width portions of the exposed portion in the signal terminal pair are formed at same positions in the extending direction.

### BRIEF DESCRIPTION OF DRAWINGS

FIG. 1 is a perspective view showing an electrical connector assembly according to an embodiment, showing a state immediately before an electrical connector is fitted and connected to a counterpart connector;

FIG. 2 is a cross-sectional view at the position of a terminal of the electrical connector assembly in FIG. 1 in a terminal arrangement direction;

FIG. 3 is a perspective view showing a part of the terminal of the electrical connector;

FIG. 4A is a side view showing a part of the terminal of the electrical connector from a terminal arrangement direction;

FIG. 4B is a partially enlarged diagram of FIG. 4A;

FIG. 5A is a perspective view showing one signal terminal;

FIG. 5B is a perspective view showing one ground terminal;

FIG. 6A is a front view showing a part of the terminal of the electrical connector from a connector width direction;

FIG. 6B is a partially enlarged diagram of FIG. 6A;

FIG. 7 is a perspective view showing a part of the counterpart terminal of the counterpart connector;

FIG. 8A is a side view showing a part of the counterpart terminal of the counterpart connector from the terminal arrangement direction;

FIG. 8B is a partially enlarged diagram of FIG. 8A;

FIG. 9A is a perspective view showing one counterpart signal terminal simple substance;

FIG. 9B is a perspective view showing one counterpart ground terminal;

FIG. 10A is a front view showing a part of the counterpart terminal of the counterpart connector from the connector width direction;

FIG. 10B is a partially enlarged diagram of FIG. 10A;

FIG. 11 is a cross-sectional view at the position of a terminal in the terminal arrangement direction of the electrical connector assembly, showing a fitted and connected state;

FIG. 12 is an enlarged cross-sectional view showing an arm portion of the terminal and a counterpart arm portion of the counterpart terminal shown in FIGS. 9A and 9B;

FIG. 13A is a graph showing the measurement result of the impedance in the case in which signals are transmitted using pluralities of types of terminals and counterpart terminals in different shapes;

FIG. 13B is a graph showing the measurement result of the impedance in the case in which signals are transmitted using pluralities of types of terminals and counterpart terminals in different shapes;

FIG. 13C is a graph showing the measurement result of the impedance in the case in which signals are transmitted using pluralities of types of terminals and counterpart terminals in different shapes; and

FIG. 13D is a graph showing the measurement result of the impedance in the case in which signals are transmitted using pluralities of types of terminals and counterpart terminals in different shapes.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An object of the present disclosure is to provide an electrical connector below. In this electrical connector, it is easy to manufacture a signal terminal in a normal shape, and it is possible to sufficiently secure the electrical bond strength between the signal terminals in the portions of the signal terminals exposed to the air. It is possible to excellently suppress an excessive deterioration in the impedance.
(1) An electrical connector according to the present disclosure includes: a plurality of signal terminals having a shape where a metal plate member is bent in a plate thickness direction and arranged such that one direction parallel to a surface of a plate is an arrangement direction; and a housing that retains the plurality of signal terminals. A direction at a right angle with respect to the arrangement direction is a fitting direction that is a direction of fitting and connecting a counterpart connector.

In the electrical connector, the plurality of signal terminals includes a signal terminal pair having a pair of signal terminals adjacent to each other, and a differential signal is transmissible by the signal terminal pair, the signal terminals of the signal terminal pair have an exposed portion exposed and extending from the housing, the exposed portion has a projection and a recess formed on both side edges of the exposed portion extending in an extending direction, a wide width portion formed in a range corresponding to the projection, and a narrow width portion formed in a range corresponding to the recess, the narrow width portion having a terminal width narrower than that of the wide width portion, and the wide width portions and the narrow width portions of the exposed portion in the signal terminal pair are formed at same positions in the extending direction.

The signal terminals of the signal terminal pair individually have a projection and a recess that are alternately formed on the side edge of the exposed portion. Wide width portions corresponding to the projection and narrow width portions corresponding to the recess are at the same positions in the extending direction. In such a structure, the signal terminal has a wide width portion with a wide terminal width. As a result, in the manufacture of the signal terminal, it is possible to largely secure the terminal width dimension on the surface, and thus, the area of the plate that can be pressed by a stripper, when the metal plate is cut. Therefore, sharing deformation in the exposed portion caused by cutting is difficult to occur. Accordingly, the signal terminal in a normal shape is easy to form by bending after that.

In the exposed portion of the signal terminal pair, the impedance easily becomes low due to the wide terminal width in the range of the wide width portion. In order to improve the electrical bond strength in the signal terminal pair, when the side edges of the wide width portion are brought close to each other, the impedance easily becomes even lower. On the other hand, in the range of the narrow width portion, since the terminal width is small and the space between the side edges facing each other is larger than the space between the projections, the impedance easily becomes high. Therefore, the exposed portion is provided with the wide width portion as well as the narrow width portion, and thus, it is possible to relax the degree of deterioration in the impedance in the exposed portion as a whole, even though the side edges of the wide width portion are brought close to each other. In the range of the wide width portion, the side edges are brought close to each other, and thus, it is possible to improve the electrical bond strength between the signal terminals.
(2) in the aspect of (1), the housing may have a fixing housing and a movable housing relatively movable with respect to the fixing housing, the signal terminal may be provided so as to be provided over the fixing housing and the movable housing, the exposed portion may be located between the fixing housing and the movable housing, and the exposed portion may permit relative movement of the movable housing by elastic displacement, and the exposed portions of the signal terminals may have a line symmetry shape with respect to a center line extending in the extending direction at a center position of a terminal width in the arrangement direction.

The exposed portion is formed in a line symmetry shape as described above, bias is difficult to occur in the elastic displacement toward the terminal width direction, i.e., bias is difficult to occur in the elastic displacement toward one side in the terminal arrangement direction and in the displacement toward the other side. In other words, it is possible to elastically displace the exposed portion equally on both sides. Consequently, it is possible to obtain an excellent floating of the movable housing in the arrangement direction described above.
(3) In the aspect of (2), both side edges of the narrow width portion and both side edges of the wide width portion may have a linear shape extending in the extending direction. The exposed portion is displaced in inclination when the exposed portion is elastically displaced in the terminal arrangement direction. In the aspect of (3), both side edges of the narrow width portion and both side edges of the wide width portion are in a linear shape. As a result, before and after the exposed portion is elastically displaced, it is possible to almost constantly maintain the space between the side edges of the exposed portions adjacent to each other. Consequently, it is possible to excellently suppress the contact of the side edges of the exposed portions adjacent to each other when the exposed portion is elastically displaced.
(4) In any of the aspects of (1) to (3), the pair of signal terminals may be disposed at a position where the space between the wide width portions is the plate thickness dimension of the signal terminal or less. Since the space between the wide width portions is the plate thickness dimension of the signal terminal or less, it is possible to sufficiently increase the electrical bond strength in the signal terminal pair in the range of the wide width portion.

According to the aspects of the present disclosure as described above, it is possible to provide an electrical connector below. In this electrical connector, the signal terminal is easily manufactured in a normal shape, and it is possible to significantly secure the electrical bond strength between the signal terminals in the portions of the signal terminals exposed in the air. It is possible to excellently suppress an excessive deterioration in the impedance.

In the following, an embodiment of the present disclosure will be described in conjunction with the accompanying drawings.

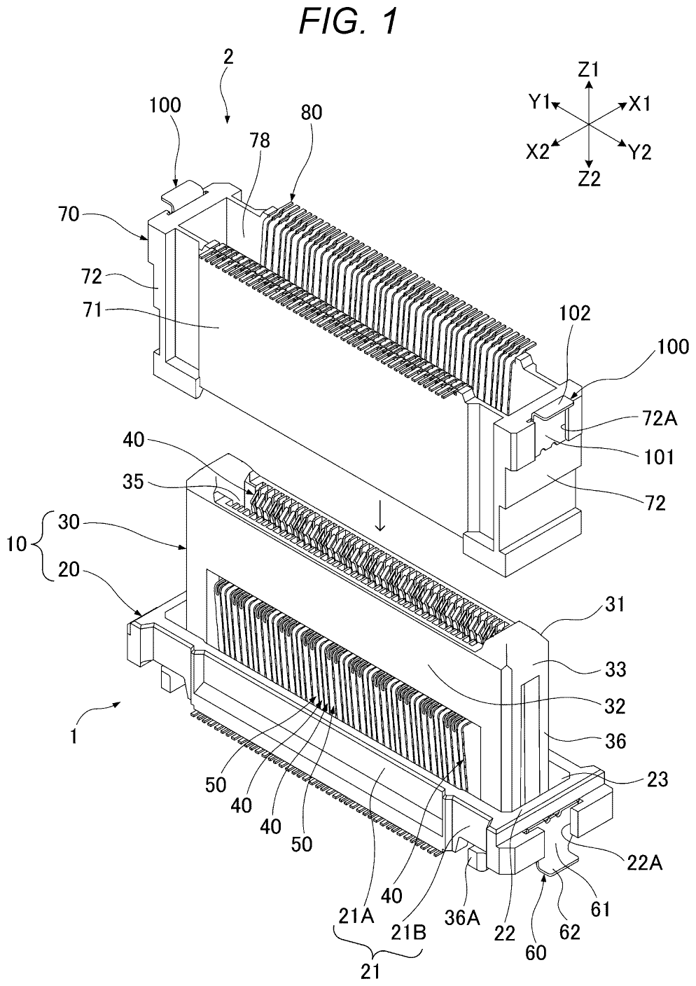

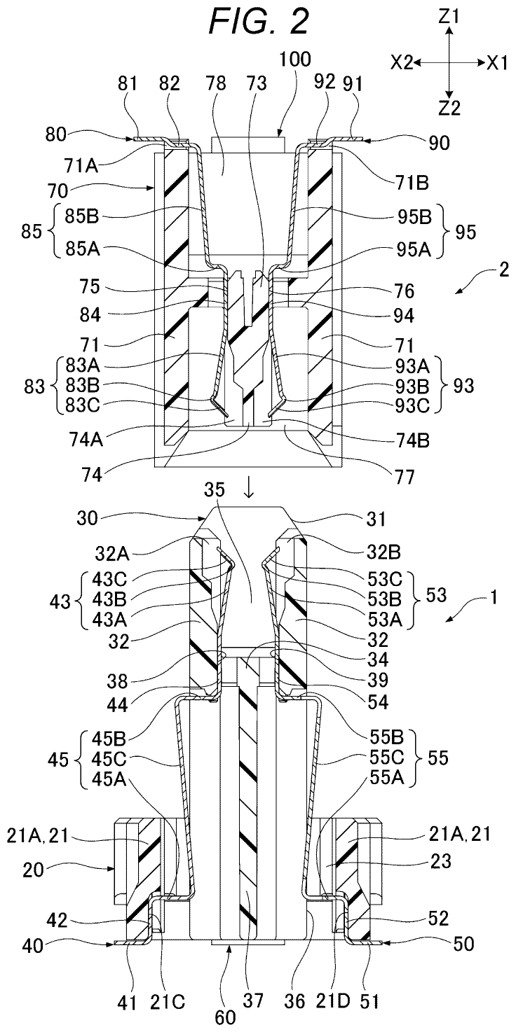

In the present embodiment, as shown in FIGS. 1 and 2, an electrical connector 1 (in the following, referred to as the “connector 1”) and a counterpart connector 2 that is fitted into and connected to the connector 1 constitute an electrical connector assembly. The connector 1 and the counterpart connector 2 are circuit board electrical connectors mounted on different circuit boards (not shown). In the present embodiment, the connector 1 and the counterpart connector 2 are used for transmitting differential signals.

The connector 1 is disposed on a mounting surface of a circuit board (not shown) having the mounting surface at a right angle with respect to a vertical direction (Z-axis direction). The counterpart connector 2 is disposed on a mounting surface of another circuit board (not shown) having the mounting surface at a right angle with respect to the vertical direction. The connectors 1 and 2 are fitted into and connected to each other as the vertical direction is a fitting direction of the connectors in the state in which the mounting surfaces of the circuit board and the other circuit board face each other in the vertical direction. More specifically, as shown by arrows in FIGS. 1 and 2, the connector 1 is structured such that the counterpart connector 2 is fitted into and connected to the connector 1 from above. In other words, in the connector 1, an upper side (Z1 side) is a fitting side to the counterpart connector 2. In the counterpart connector 2, a lower side (Z2 side) is a fitting side (in the following, referred to as “the counterpart fitting side”) with respect to the connector 1.

The connector 1 has a housing 10 extending in one direction parallel to (Y-axis direction) with respect to the mounting surface of the circuit board as the one direction is a longitudinal direction, a plurality of signal terminals 40 and a plurality of ground terminals 50 arranged and retained on the housing 10 as the longitudinal direction is a terminal arrangement direction, and two fixing metal parts 60 retained on the housing 10.

In the following, in the case in which it is unnecessary to distinguish between the signal terminal 40 and the ground terminal 50, “the terminals 40 and 50” are collectively referred to as a general term, for convenience of explanation. As shown in FIG. 2, the terminals 40 and 50 are arranged in the terminal arrangement direction (Y-axis direction) parallel to the surfaces of the plates of the terminals 40 and 50 such that the terminals 40 and 50 form two terminal lines facing each other in the connector width direction (X-axis direction). In the two terminal lines, the numbers of the terminals 40 and 50 to be arranged are equal between the terminal lines, and the terminals 40 and 50 are provided in the same range in the terminal arrangement direction. In the terminal lines, the terminals 40 and 50 are mixed together. The signal terminal 40 of one terminal line faces the ground terminal 50 of the other terminal line, and the ground terminal 50 of the one terminal line faces the signal terminal 40 of the other terminal line. The direction at a right angle with respect to the arrangement direction of the terminals 40 and 50 is the fitting direction, which is the direction in which the counterpart connector 2 is fitted and connected in the connector 1. The details of disposing of the terminals 40 and 50 in the terminal lines will be described later.

The housing 10 is made of an electric insulating material such as a resin, and has a fixing housing 20 attached to the circuit board through the terminals 40 and 50, and a movable housing 30 that is a member separate from the fixing housing 20 and is relatively movable with respect to the fixing housing 20. In the present embodiment, the terminals 40 and 50 are provided so as to be provided over the fixing housing 20 and the movable housing 30. The elastic displacement of the terminals 40 and 50 (exposed portions 45 and 55, described later) permits the relative movement (floating) of the movable housing 30 with respect to the fixing housing 20.

The fixing housing 20 has an approximately rectangular parallelepiped outer shape extending in the terminal arrangement direction as the longitudinal direction. The fixing housing 20 has a surrounding wall in a rectangular frame shape having an internal space 23 penetrating in the vertical direction. As shown in FIG. 1, the surrounding wall of the fixing housing 20 has two fixing-side side walls 21 extending in the terminal arrangement direction and two fixing-side end walls 22 extending in the connector width direction and coupling the end portions of the fixing-side side walls 21 to each other.

As shown in FIG. 1, the fixing-side side wall 21 has a middle wall 21A extending across the terminal arranging range and a regulating portion 21B located on both outer sides of the middle wall 21A and permitting the regulation of the upward movement of the movable housing 30. The underside of the regulating portion 21B is located on the upper side from the underside of the middle wall 21A.

As shown in FIG. 2, the lower part of the middle wall 21A is formed with a plurality of fixing-side narrow-width retaining portions 21C that attaches the signal terminal 40 and a plurality of fixing-side wide-width retaining portions 21D that attaches the ground terminal 50. FIG. 2 shows the fixing-side narrow-width retaining portion 21C formed on the middle wall 21A on the X2 side and the fixing-side wide-width retaining portion 21D formed on the middle wall 21A on the X1 side. The fixing-side narrow-width retaining portion 21C and the fixing-side wide-width retaining portion 21D are formed in a groove shape pitted downward from the inner side surface of the lower part of the middle wall 21A and extending in the vertical direction. The fixing-side wide-width retaining portion 21D is larger than the fixing-side narrow-width retaining portion 21C in the terminal arrangement direction, i.e., its width is wider.

As shown in FIG. 1, the fixing-side end wall 22 has a metal-part retaining portion 22A that retains the fixing metal part 60 at its lower part. The metal-part retaining portion 22A is formed in a groove shape extending in the vertical direction and penetrating the fixing-side end wall 22 and is formed to press-fit and retain the fixing metal part 60.

As shown in FIGS. 1 and 2, the movable housing 30 has a fitting portion 31 that fits into the counterpart connector 2 and an extension wall 36 and a center wall 37 (see FIG. 2) extending from the fitting portion 31. The lower part of the movable housing 30 is accommodated in the internal space 23 of the fixing housing 20. The fitting portion 31 has two movable-side side walls 32 extending in the terminal arrangement direction, two movable-side end walls 33 that couple the end portions of the movable-side side walls 32 extending in the connector width direction, and a bottom wall 34 that blocks the lower end of the internal space of the fitting portion 31. The internal space of the fitting portion 31, i.e., the space that is surrounded by the movable-side side wall 32, the movable-side end wall 33, and the bottom wall 34, and opened upward, is formed as a receiving portion 35 that receives a part of the counterpart connector 2.

As shown in FIG. 2, the movable-side side wall 32 is formed with a plurality of narrow-width accommodating grooves 32A to accommodate a part of the signal terminal 40 and a plurality of wide-width accommodating grooves 32B to accommodate a part of the ground terminal 50. FIG. 2 shows the narrow-width accommodating groove 32A formed on the movable-side side wall 32 on the X2 side and the wide-width accommodating groove 32B formed on the movable-side side wall 32 on the X1 side. The narrow-width accommodating groove 32A and the wide-width accommodating groove 32B are pitted downward from the inner side surface of the movable-side side wall 32 in a range except the lower part of the movable-side side wall 32 and extend in the vertical direction. The wide-width accommodating groove 32B is formed to have a groove width wider than that of the narrow-width accommodating groove 32A, i.e., its width is wider in the terminal arrangement direction.

In the present embodiment, as shown in FIG. 1, the outer side surface of the movable-side side wall 32 is flat across the entire range. As an exemplary modification, the outer side surface of the movable-side side wall 32 may be formed with a plurality of grooves extending in the vertical direction so as to be arranged along the terminal arrangement direction. Forming such grooves is possible to suppress deformation of the movable-side side wall 32, which warps in the wall thickness direction (connector width direction), when the movable housing 30 is shaped.

As shown in FIG. 2, the movable-side side wall 32 and the bottom wall 34 are formed with a movable-side narrow-width retaining portion 38 that attaches the signal terminal 40 and a movable-side wide-width retaining portion 39 that attaches the ground terminal 50. FIG. 2 shows the movable-side narrow-width retaining portion 38 formed on the movable-side side wall 32 on the X2 side and the movable-side wide-width retaining portion 39 formed on the movable-side side wall 32 on the X1 side. The movable-side narrow-width retaining portion 38 and the movable-side wide-width retaining portion 39 have a groove shape extending in the vertical direction, and the groove pits downward from the side surface of the lower part of the movable-side side wall 32 to penetrate the bottom wall 34. The movable-side wide-width retaining portion 39 is larger than the movable-side narrow-width retaining portion 38 in the terminal arrangement direction, i.e., its width is wider. The movable-side narrow-width retaining portion 38 communicates with the narrow-width accommodating groove 32A, and the movable-side wide-width retaining portion 39 communicates with the wide-width accommodating groove 32B. The movable-side narrow-width retaining portion 38 accommodates, press-fits, and retains a part of the signal terminal 40, and supports the surface of the plate of that part (the surface at a right angle with respect to the connector width direction) by the inner surface of the groove. The movable-side wide-width retaining portion 39 accommodates, press-fits, and retains a part of the ground terminal 50, and supports the surface of the plate of that part (the surface at a right angle with respect to the connector width direction) by the inner surface of the groove.

As shown in FIG. 1, the extension wall 36 extends downward from the movable-side end wall 33. The lower part of the extension wall 36 is provided with a regulated portion 36A projecting in the connector width direction. The regulated portion 36A is located right under the regulating portion 21B of the fixing housing 20 and is contactable with the regulating portion 21B from below. The regulated portion 36A contacts the regulating portion 21B from below, and thus, a predetermined amount of upward movement of the movable housing 30 is regulated.

As shown in FIG. 2, the center wall 37 extends downward from the bottom wall 34. The center wall 37 extends from the underside of the bottom wall 34 to the lower end position of the extension wall 36 in the center region in the connector width direction of the bottom wall 34. The center wall 37 extends across the entire range between the extension walls 36 in the terminal arrangement direction and couples the extension walls 36. As shown in FIG. 2, the center wall 37 separates the signal terminal 40 from the ground terminal 50, facing each other in the connector width direction.

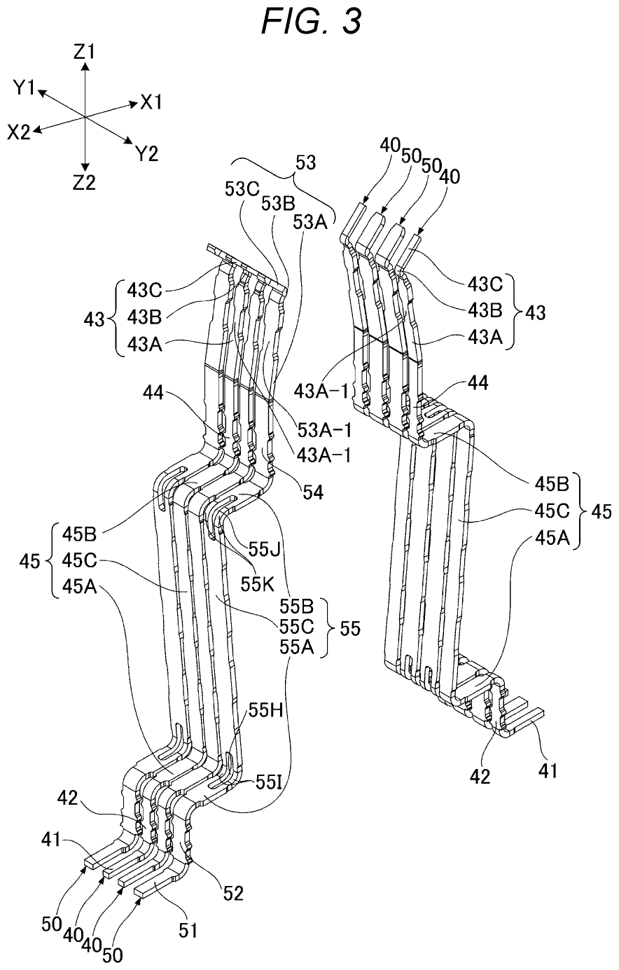

The terminals 40 and 50 are a so-called bent terminal formed by bending a metal band-shaped piece (metal plate member) in a plate thickness direction. The terminals 40 and 50 are disposed such that the terminal width direction matches the terminal arrangement direction (Y-axis direction). In the terminal lines, a plurality of terminal groups formed of two signal terminals 40 and two ground terminals 50 is arranged. As shown in FIG. 3 on the X2 side, this terminal group includes two signal terminals 40 adjacent to each other and has a signal terminal pair to transmit differential signals, and the ground terminal 50 is one each disposed on both sides of the signal terminal pair. As described above, the ground terminal 50 is disposed on both sides of the signal terminal pair, and thus, the crosstalk between the signal terminal pairs adjacent to each other is excellently suppressed. As described above, the plurality of signal terminals 40 includes a signal terminal pair having a pair of signal terminals 40 adjacent to each other, and this signal terminal pair allows transmission of the differential signals.

As shown in FIG. 3, on the X1 side, the ground terminal 50 is disposed facing the signal terminal 40 on the X2 side, and the signal terminal 40 is disposed facing the ground terminal 50 on the X2 side. As described above, the signal terminal 40 and the ground terminal 50 are disposed facing each other in the connector width direction, and thus, the crosstalk between the signal terminal 40 of the terminal line on the X1 side and the signal terminal 40 of the terminal line on the X2 side is excellently suppressed.

In the terminal lines, in addition to the plurality of terminal groups, one signal terminal 40 is disposed at one distal end position in the terminal arrangement direction. More specifically, as shown in FIG. 1, on the terminal line on the X1 side, the signal terminal 40 is disposed at a position closest to the Y1 side in the terminal arrangement direction. On the terminal line on the X2 side, the signal terminal 40 is disposed at a position closest to the Y2 side in the terminal arrangement direction. In other words, the terminals 40 and 50 of the two terminal lines are arranged in point symmetry when viewed from the vertical direction. The signal terminal 40 of the terminal line on the X1 side located closest to the Y1 side and the signal terminal 40 of the terminal line on the X2 side located closest to the Y2 side are used for transmission of a type of signal that is different from the differential signal. As an exemplary modification, these signal terminals 40 may be used as ground terminals.

As shown in FIGS. 2 to 6, the signal terminal 40 has a connecting portion 41 formed at one end portion located in the lower part, a fixing-side retained portion 42 extending upward from the connecting portion 41, an arm portion 43 formed at the other end portion located above the connecting portion 41 and inward in the connector width direction, a movable-side retained portion 44 extending downward from the arm portion 43, and the exposed portion 45 that couples the fixing-side retained portion 42 to the movable-side retained portion 44.

As shown in FIG. 2, the connecting portion 41 extends outward in the connector width direction, right under the middle wall 21A. The connecting portion 41 is formed so as to be solder-connected to a corresponding circuit part (e.g., a pad) on the mounting surface of the circuit board (not shown). The fixing-side retained portion 42 is bent at a right angle at the inner end of the connecting portion 41 (the end portion on the inner side in the connector width direction) and extends upward. The fixing-side retained portion 42 is press-fitted into and retained in the fixing-side narrow-width retaining portion 21C of the fixing housing 20.

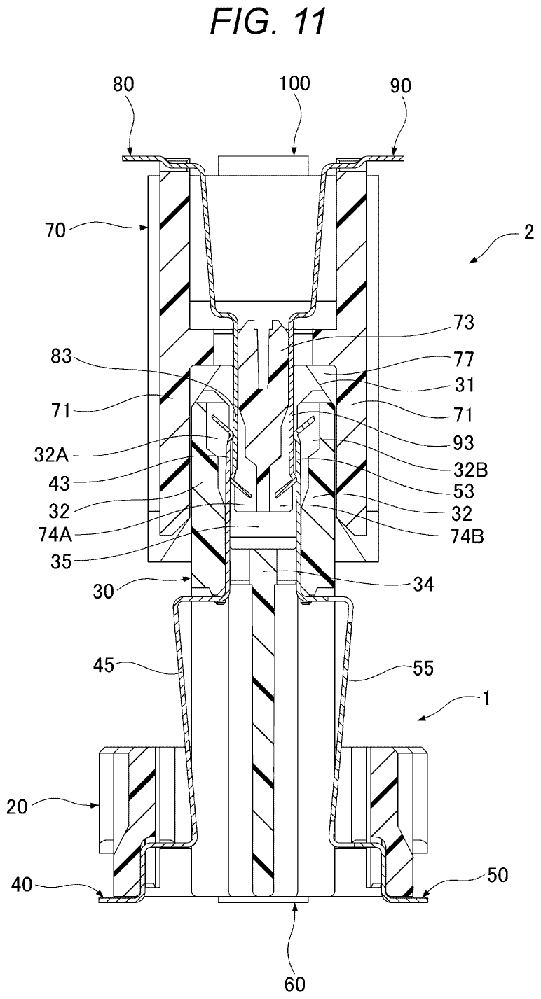

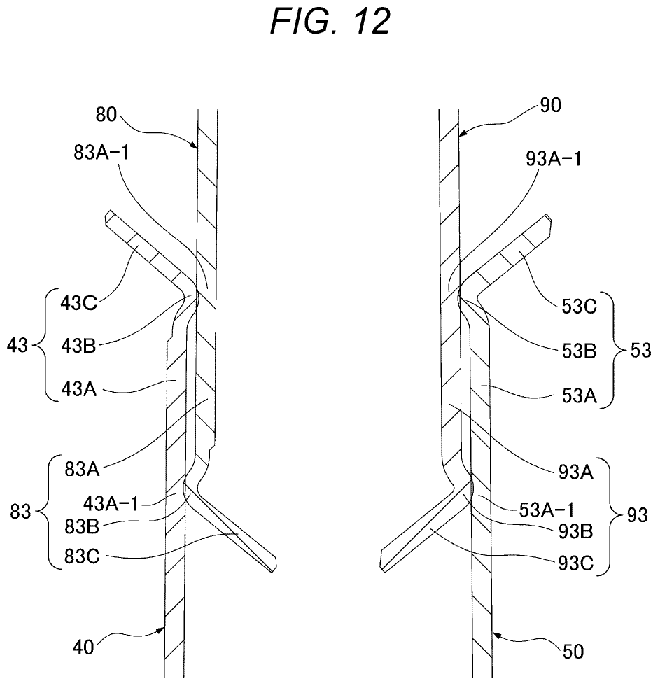

As shown in FIG. 2, the arm portion 43 extends vertically along the narrow-width accommodating groove 32A of the movable housing 30 and is disposed facing the receiving portion 35. The arm portion 43 is elastically displaceable in the plate thickness direction, i.e., in the connector width direction. The arm portion 43 is contactable with a counterpart signal terminal 80 provided on the counterpart connector 2, as the surface of the plate is the contact surface (see FIGS. 11 and 12).

As shown in FIGS. 2 to 6, the arm portion 43 has a first contacting portion 43A and a second contacting portion 43B that contact the counterpart signal terminal 80 and a guide portion 43C that guides the counterpart signal terminal 80. The first contacting portion 43A extends linearly along the vertical direction, specifically, so as to be slightly inclined inwardly in the connector width direction as the first contacting portion 43A moves upward. As shown in FIGS. 3, 5A, and 6A, a middle portion 43A-1 of the first contacting portion 43A in the vertical direction is formed to have a terminal width narrower than that of the other portions, i.e., its width is narrow.

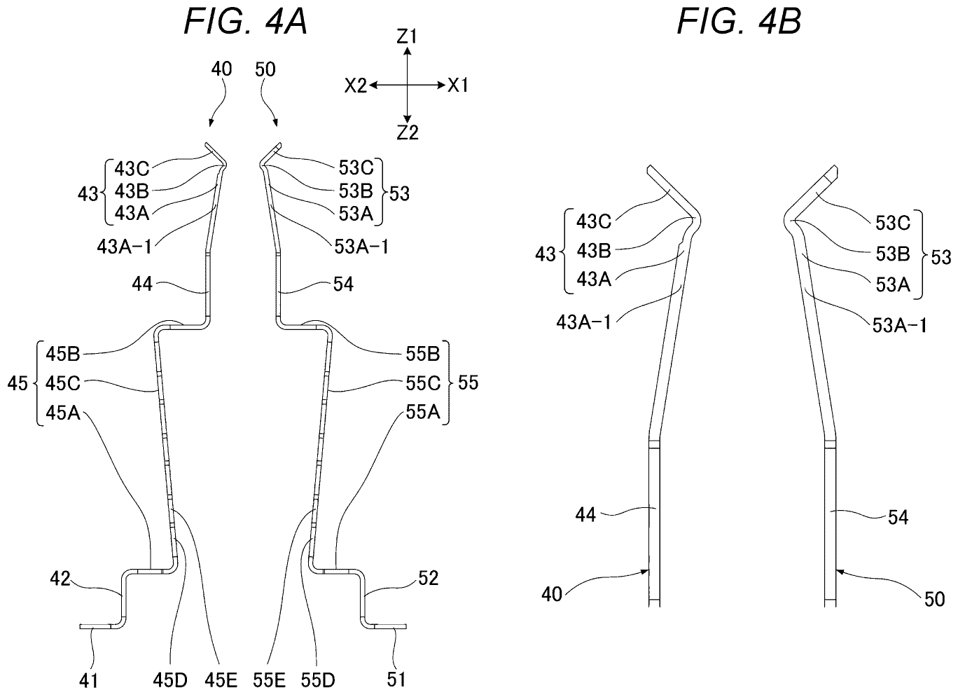

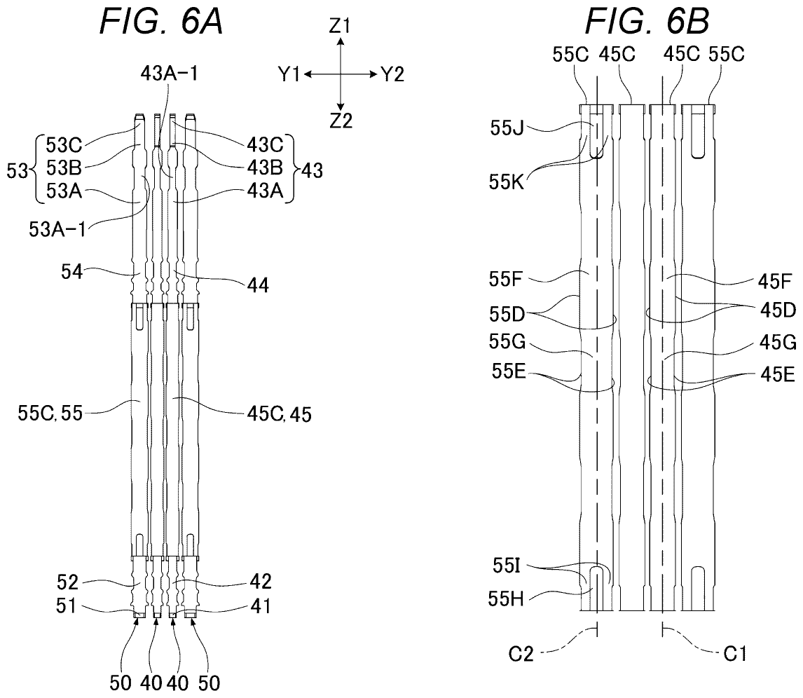

The second contacting portion 43B is bent so as to project inwardly in the connector width direction above the first contacting portion 43A. The guide portion 43C extends to be inclined outwardly in the connector width direction as the guide portion 43C moves upward from the top end of the second contacting portion 43B. As shown in FIG. 6A, the second contacting portion 43B and the guide portion 43C are formed to have a terminal width slightly narrower than that of the middle portion 43A-1. The second contacting portion 43B and the guide portion are crushed in the plate thickness direction. Consequently, as shown in FIGS. 4A and 4B, the second contacting portion 43B and the guide portion 43C are formed to have a plate thickness dimension smaller than the plate thickness dimension of the first contacting portion 43A. In other words, the second contacting portion 43B and the guide portion 43C are thinner than the first contacting portion 43A. In the present embodiment, the second contacting portion 43B and the guide portion 43C are formed to have a plate thickness dimension one-half or more and three-quarters or less of the plate thickness dimension of the first contacting portion 43A. The second contacting portion 43B and the guide portion 43C are formed to have a plate thickness dimension smaller than the plate thickness dimension of a first counterpart contacting portion 83A formed on the counterpart signal terminal 80 (see FIG. 12). In other words, the second contacting portion 43B and the guide portion 43C are thinner than the first counterpart contacting portion 83A.

In the present embodiment, the second contacting portion 43B and the guide portion 43C are formed to have a plate thickness dimension one-half or more and three-quarters or less of the plate thickness dimension of the first counterpart contacting portion 83A. The plate thickness dimension of the second contacting portion 43B is formed one-half or more of the plate thickness dimension of the first contacting portion 43A and the first counterpart contacting portion 83A, and thus, it becomes easily secure the withstandable strength against the contact pressure of the second contacting portion 43B in contacting the first counterpart contacting portion 83A. The plate thickness dimension of the second contacting portion 43B is formed three-quarters or less of the plate thickness dimension of the first contacting portion 43A, and thus, it is possible to sufficiently reduce the cross-sectional area of the second contacting portion 43B at the contact position with the first counterpart contacting portion 83A. Consequently, it becomes easy to sufficiently suppress a sudden change in the impedance at the contact position. The plate thickness dimension of the second contacting portion 43B is formed three-quarters or less of the plate thickness dimension of the first counterpart contacting portion 83A, i.e. the plate thickness dimension of the first counterpart contacting portion 83A is formed four-thirds or more of the plate thickness dimension of the second contacting portion 43B, and thus, it is possible to sufficiently thicken the first counterpart contacting portion 83A to the second contacting portion 43B. As a result, an excessive elastic displacement of the first counterpart contacting portion 83A is easily suppressed.

As shown in FIG. 2, the exposed portion 45 extends so as to be exposed from the fixing housing 20 and the movable housing 30 between the fixing housing 20 and the movable housing 30. The exposed portion 45 couples the top end of the fixing-side retained portion 42 to the lower end of the movable-side retained portion 44. The exposed portion 45 has a first elastic portion 45A, a second elastic portion 45B, and a third elastic portion 45C, and has an approximately crank shape when viewed from the terminal arrangement direction. The exposed portion 45 is elastically displaceable in the connector width direction (X-axis direction), the terminal arrangement direction (Y-axis direction), and the vertical direction (Z-axis direction).

The first elastic portion 45A is bent at a right angle at the top end of the fixing-side retained portion 42 and linearly extends inward toward the connector width direction. The second elastic portion 45B is bent at a right angle at the lower end of the movable-side retained portion 44 and linearly extends outward in the connector width direction. The third elastic portion 45C extends along the vertical direction between the inner end of the first elastic portion 45A and the outer end of the second elastic portion 45B. More specifically, the third elastic portion 45C linearly extends so as to be slightly inclined toward the connector width direction outward as the third elastic portion 45C moves upward from the inner end of the first elastic portion 45A. The third elastic portion 45C couples the inner end of the first elastic portion 45A to the outer end of the second elastic portion 45B.

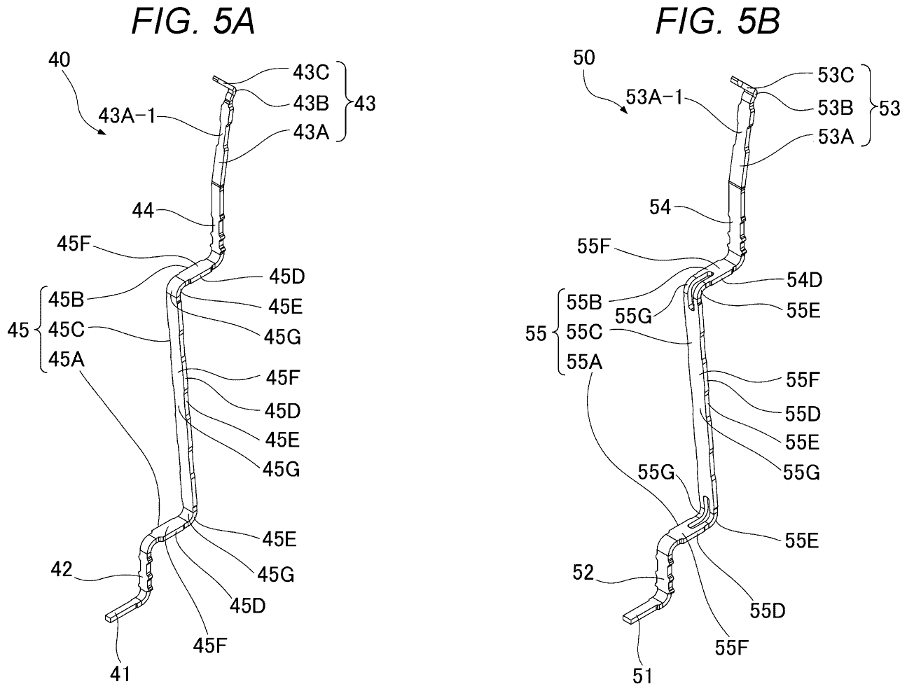

As shown in FIGS. 5A and 6B, in the exposed portion 45, a projection 45D and a recess 45E are alternately formed across the entire range on both side edges of the exposed portion 45 extending in the extending direction. In other words, the side edges of the exposed portion 45 include a plurality of projections 45D and a plurality of recesses 45E. As shown in FIG. 5A, on both side edges of the first elastic portion 45A and the second elastic portion 45B, one projection 45D is formed. On both side edges of the third elastic portion 45C, a plurality of projections 45D and a plurality of recesses 45E are formed. On both side edges of the bent part located on the boundary between the first elastic portion 45A and the third elastic portion 45C and on both side edges of the bent part located on the boundary between the first elastic portion 45A and the second elastic portion 45B, the recess 45E is formed.

The projections 45D and the recesses 45E on both side edges are at the same positions in the extending direction. In other words, the exposed portion 45 has a line symmetry shape with respect to the center line extending in the extending direction at the center position in the terminal width direction (Y-axis direction). FIG. 6B shows a state in which the third elastic portion 45C of the exposed portion 45 forms line symmetry with respect to the center line C1.

In the exposed portion 45, a wide width portion 45F is formed in the range corresponding to the projection 45D in the extending direction, and a narrow width portion 45G having a terminal width narrower than that of the wide width portion 45F is formed in the range corresponding to the recess 45E in the extending direction. Therefore, the wide width portion 45F and the narrow width portion 45G are alternately provided across the entire range of the exposed portion 45 in the extending direction. More specifically, as shown in FIG. 5A, one wide width portion 45F is formed on the first elastic portion 45A and the second elastic portion 45B, and a plurality of wide width portions 45F and a plurality of narrow width portions 45G are formed on the third elastic portion 45C. On the bent part located on the boundary between the first elastic portion 45A and the third elastic portion 45C and on the bent part located on the boundary between the first elastic portion 45A and the second elastic portion 45B, the narrow width portion 45G is formed. Both side edges of the wide width portion 45F and the narrow width portion 45G have a linear shape extending in the extending direction.

The wide width portions 45F and the narrow width portions 45G are at the same positions in the extending direction in the two exposed portions 45 adjacent to each other in the signal terminal pair. Therefore, the side edges of the wide width portion 45F facing each other are brought close to each other. As a result, it is possible to improve the electrical bond strength between the signal terminals 40 in the range of the wide width portion 45F. In the present embodiment, the space between the side edges of the wide width portion 45F is set to the plate thickness dimension or less of the exposed portion 45. That is, the pair of signal terminals adjacent to each other 40 is disposed at a position such that the space of the wide width portions 45F is the plate thickness dimension or less of the signal terminal 40. The wide width portions 45F are brought close to each other in such a narrow space, and thus, it is possible to further improve the electrical bond strength between the signal terminal pair.

Since the exposed portion 45 is exposed in the air, the impedance of the exposed portion 45 easily increases at this point. However, in the present embodiment, the wide width portion 45F having a large terminal width is provided on the exposed portion 45, and thus, the impedance is easily reduced. As a result, it is possible to suppress an increase in the impedance of the exposed portion 45. The wide width portions 45F are brought close to each other in the signal terminal pair, the electrical bond strength is increased, and the impedance is further reduced. In the present embodiment, in the exposed portion 45, the wide width portion 45F as well as the narrow width portion 45G are provided. In the range of the narrow width portion 45G, the terminal width is small, and the space between the facing side edges is larger than the space of the wide width portions 45F. As a result, in the range of the narrow width portion 45G, the impedance easily increases. As described above, in the present embodiment, the exposed portion 45 is provided with the wide width portion 45F as well as the narrow width portion 45G. Consequently, even though the side edges of the wide width portion 45F are brought close to each other brings close to each other, it is possible to relax the degree of deterioration in the impedance of the exposed portion 45 as a whole. Therefore, it is possible to excellently suppress an excessive deterioration in the impedance of the exposed portion 45.

The ground terminal 50 is disposed such that the terminal width direction matches the terminal arrangement direction (Y-axis direction). The ground terminal 50 has a shape where the signal terminal 40 is large in the terminal width direction, i.e., its width is wider.

As shown in FIGS. 2 to 6, the ground terminal 50 has a connecting portion 51 formed at one end portion located underside, a fixing-side retained portion 52 extending upward from the connecting portion 51, an arm portion 53 formed at the other end portion located above the connecting portion 51 and inward in the connector width direction, a movable-side retained portion 54 extending downward from the arm portion 53, and an exposed portion 55 that couples the fixing-side retained portion 52 to the movable-side retained portion 54.

The ground terminal 50 has a shape almost the same as the signal terminal 40 when viewed from the terminal width direction. However, the ground terminal 50 has a width wider than that of the signal terminal 40. The shapes of the arm portion 53 and the exposed portion 55 are different from the shapes of the arm portion 43 and the exposed portion 45 of the signal terminal 40.

The arm portion 53 has a first contacting portion 53A and a second contacting portion 53B that contact a counterpart ground terminal 90 provided on the counterpart connector 2, and a guide portion 53C that guides the counterpart ground terminal 90. The first contacting portion 53A has a shape the same as the shape of the first contacting portion 43A of the signal terminal 40 when viewed from the terminal width direction. As shown in FIGS. 3, 5B and 6A, in the first contacting portion 53A, a middle portion 53A-1 in the vertical direction is formed to have a width narrower than that of the other portions. As shown in FIGS. 4A and 4B, the second contacting portion 53B and the guide portion 53C are not crushed and are formed to have the same plate thickness dimension as the first contacting portion 53A. At this point, the shapes of the second contacting portion 53B and the guide portion 53C are different from the shapes of the second contacting portion 43B and the guide portion 43C of the signal terminal 40. In other words, the arm portion 53 is formed to have the same plate thickness dimension across the entire length.

As shown in FIGS. 3, 4A, and 5B, the exposed portion 55 has a first elastic portion 55A, a second elastic portion 55B, and a third elastic portion 55C. The exposed portion 55 has a shape the same as the shape of the exposed portion 45 of the signal terminal 40 when viewed from the terminal width direction. As shown in FIG. 3, in the exposed portion 55, at a bent part provided at the first elastic portion 55A and the third elastic portion 55C, a first slit 55H is formed to penetrate the bent part in the plate thickness direction in the center region in the terminal width direction. On both sides of the first slit 55H in the terminal width direction, one first narrow bar 55I is formed on both sides. In the exposed portion 55, on a bent part provided at the coupling position of the second elastic portion 55B to the third elastic portion 55C, a second slit 55J is formed to penetrate the bent part in the plate thickness direction in the center region in the terminal width direction. On both sides of the second slit 55J in the terminal width direction, one second narrow bar 55K is formed on both sides. As described above, in the exposed portion 55, the first slit 55H, the first narrow bar 551, the second slit 55J, and the second narrow bar 55K are formed. At this point, the exposed portion 55 is different from the exposed portion 45 of the signal terminal 40. The bent parts of the exposed portion 55 are elastically displaceable in the first narrow bar 55I and the second narrow bar 55K. As a result, the bent parts of the exposed portion 55 are easily elastically displaced as compared with the case in which the first slit 55H and the second slit 55J are not formed.

As shown in FIGS. 5B and 6B, in the exposed portion 55, the projection 55D and the recess 55E are alternately formed across the entire range of the exposed portion 55 extending in the extending direction on both side edges. In other words, the side edges of the exposed portion 55 include a plurality of projections 55D and a plurality of recesses 55E. As shown in FIG. 5B, on both side edges of the first elastic portion 55A and the second elastic portion 55B, one projection 55D is formed. On both side edges of the third elastic portion 55C, the plurality of projections 55D and the plurality of recesses 55E are formed. On both side edges of the bent part located on the boundary between the first elastic portion 55A and the third elastic portion 55C and on both side edges of the bent part located on the boundary between the first elastic portion 55A and the second elastic portion 55B, the recess 55E is formed.

The projections 55D and the recesses 55E on both side edges are at the same positions in the extending direction. In other words, the exposed portion 55 has a line symmetry shape at the center position in the terminal width direction (Y-axis direction) with respect to the center line extending in the extending direction. FIG. 6B shows the state in which the third elastic portion 55C of the exposed portion 55 has line symmetry with respect to the center line C2.

In the exposed portion 55, a wide width portion 55F is formed in the range corresponding to the projection 55D in the extending direction, and a narrow width portion 55G having a terminal width narrower than that of the wide width portion 55F is formed in the range corresponding to the recess 55E in the extending direction. Therefore, the wide width portion 55F and the narrow width portion 55G are alternately provided across the entire range in the extending direction of the exposed portion 55. More specifically, as shown in FIG. 5B, one wide width portion 55F is formed on the first elastic portion 55A and the second elastic portion 55B, and a plurality of wide width portions 55F and a plurality of narrow width portions 55G are formed on the third elastic portion 55C. On the bent part located on the boundary between the first elastic portion 55A and the third elastic portion 55C and on the bent part located on the boundary between the first elastic portion 55A and the second elastic portion 55B, the narrow width portion 55G is formed. On both side edges of the wide width portion 55F and the narrow width portion 55G have a linear shape extending in the extending direction.

In the projection 55D and the recess 55E, the shape located in the extending direction is the same as the projection 45D and the recess 45E of the signal terminal 40. In other words, the side edge of the exposed portion 55 of the ground terminal 50 has a shape the same as the shape of the side edge of the exposed portion 45 of the signal terminal 40. Therefore, in the ground terminal 50 and the signal terminal 40 adjacent to each other, the wide width portion 55F and the side edges of the wide width portion 45F facing each other are brought close to each other. As a result, in the wide width portion 55F and in the range of the wide width portion 45F, it is possible to improve the electrical bond strength between the ground terminal 50 and the signal terminal 40. In the present embodiment, the space between the side edges of the wide width portion 55F and the wide width portion 45F is set to the plate thickness dimension or less of the exposed portion 55 and the exposed portion 45. The wide width portion 55F and the wide width portion 45F are brought close to each other in such a narrow space, and thus, it is possible to further improve the electrical bond strength between the ground terminal 50 and the signal terminal 40.

As shown in FIG. 1, the fixing metal part 60 is formed by bending a metal plate member in the plate thickness direction. The fixing metal part 60 has a retained plate 61 press-fitted into and retained on the metal-part retaining portion 22A of the fixing-side end wall 22 and a fixed leg 62 fixed to the circuit board. The retained plate 61 has a flat plate shape having the surface of the plate at a right angle with respect to the terminal arrangement direction. The retained plate 61 is press-fitted and retained on the metal-part retaining portion 22A on both sides of the side edge portions extending in the vertical direction. The fixed leg 62 has a plate shape bent at a right angle at the lower end of the retained plate 61 and extending outward in the terminal arrangement direction. The fixed leg 62 is solder-connected and fixed to a corresponding part, such as a pad, formed on the mounting surface of the circuit board.

The connector 1 is manufactured by the following procedures. First, the manufacturing processes of the signal terminal 40 will be described. The signal terminal 40 is formed by cutting a metal plate member to crush a part of the obtained metal band-shaped piece and bending the metal band-shaped piece in the plate thickness direction. More specifically, first, the surface of the plate of the metal plate member disposed on a cutting mold die (not shown) is held by a stripper (not shown). Subsequently, the part corresponding to one side edge of the signal terminal 40 in the metal plate member is cut by a punch (not shown) in the plate thickness direction (first cutting process). After that, a part corresponding to the other side edge of the metal plate member is also cut (second cutting process). As a result, the metal plate band-shaped piece is obtained. Subsequently, the parts corresponding to the second contacting portion 43B and the guide portion 43C of the metal band-shaped piece are crushed in the plate thickness direction, and the parts are formed thinner than the other parts. Subsequently, the metal band-shaped piece is bent in the plate thickness direction, and thus, the signal terminal 40 is obtained.

The ground terminal 50 is manufactured by processing a metal plate member having the same thickness as a metal plate member used for manufacturing the signal terminal 40. Since the manufacturing processes of the ground terminal 50 are the same as the manufacturing processes of the signal terminal 40, except that crushing is not performed, the description is omitted.

In the present embodiment, the terminals 40 and 50 have the wide width portions 45F and 55F with a wide terminal width. As a result, in the second cutting process of the terminals 40 and 50, it is possible to largely secure the terminal width dimension, and thus, the area of the surface of the plate to be held by a stripper. Therefore, the sharing of deformation between the third elastic portions 45C and 55C due to the cutting process is difficult to occur, and thus, it is possible to suppress the formation of a metal band-shaped piece in a twisted shape. Consequently, it is possible to easily produce the terminals 40 and 50 in a normal shape by bending a metal band-shaped piece.

In the present embodiment, the side edge of the exposed portion 45 of the signal terminal 40 and the side edge of the exposed portion 55 of the ground terminal 50 have the same shape. Therefore, it is possible to use the same cutting mold for both the manufacturing processes of the signal terminal 40 and the manufacturing processes of the ground terminal 50. As a result, it is possible to curtail manufacturing costs for the terminals 40 and 50.

Next, the assembly process of the connector 1 will be described. First, the movable-side retained portion 44 of the signal terminal 40 and the movable-side retained portion 54 of the ground terminal 50 are press-fitted into the movable-side narrow-width retaining portion 38 and the movable-side wide-width retaining portion 39 of the movable housing 30 from below. Consequently, the terminals 40 and 50 are retained in the movable housing 30.

Subsequently, the fixing-side retained portion 42 of the signal terminal 40 and the fixing-side retained portion 52 of the ground terminal 50 are press-fitted into the fixing-side narrow-width retaining portion 21C of the fixing housing 20 and the fixing-side wide-width retaining portion 21D from below, and the terminals 40 and 50 is retained in the fixing housing 20. Subsequently, the retained plate 61 of the fixing metal part 60 is press-fitted into the metal-part retaining portion 22A of the fixing housing 20 from above, and the fixing metal part 60 is retained in the fixing housing 20. As described above, the terminals 40 and 50 and the fixing metal part 60 are attached to the housing 10, and the connector 1 is completed. In addition, the fixing metal part 60 may be attached to the fixing housing 20 prior to the terminals 40 and 50. The fixing metal part 60 may be attached to the fixing housing 20 simultaneously with attaching the terminals 40 and 50.

As shown in FIGS. 1 and 2, the counterpart connector 2 has a counterpart housing 70, a plurality of counterpart signal terminals 80 and a plurality of counterpart ground terminals 90, and two fixing metal parts 100 retained in the counterpart housing 70. The counterpart housing 70 extends as one direction (Y-axis direction) parallel to the mounting surface of the circuit board (not shown) is the longitudinal direction. The plurality of counterpart signal terminals 80 and the plurality of counterpart ground terminals 90 (in the following, referred to as “counterpart terminals 80 and 90” when these terminals are not necessarily distinguished) are arranged and retained in the counterpart housing 70 as the longitudinal direction is the terminal arrangement direction.

In the following, the structure of the counterpart connector 2 will be described with reference to a state in which the counterpart connector 2 is in the attitude as shown in FIGS. 1 and 2. Therefore, in the counterpart connector 2, the Z1 side to be mounted on the circuit board is referred to as “an upper part”, and the Z2 side to be fitted into the connector 1 is referred to as “a lower part”. The counterpart housing 70 is made of an electric insulating material such as a resin and has an approximately rectangular parallelepiped outer shape extending as the terminal arrangement direction (Y-axis direction) is the longitudinal direction. The counterpart housing 70 has a partition wall 73 that divides, into two parts, a surrounding wall open to both the upper part and the lower part having a rectangular frame shape and the internal space of the surrounding wall in the vertical direction, and an insertion wall 74 extending from the underside of the partition wall 73 to the lower part.

As shown in FIG. 1, the surrounding wall of the counterpart housing 70 has two counterpart side walls 71 extending in the terminal arrangement direction and two counterpart end walls 72 extending in the connector width direction and coupling the end portions of the counterpart side walls 71. As shown in FIG. 2, a space located in the lower part from the partition wall 73 and accommodating the insertion wall 74 in the internal space of the surrounding wall forms a counterpart receiving portion 77 that receives a part of the connector 1 from below.

As shown in FIG. 2, the upper part of the counterpart side wall 71 is formed with a plurality of one-end-side narrow-width retaining portions 71A that attaches the counterpart signal terminal 80 and a one-end-side wide-width retaining portion 71B that attaches the counterpart ground terminal 90. FIG. 2 shows the one-end-side narrow-width retaining portion 71A formed on the counterpart side wall 71 on the X2 side and the one-end-side wide-width retaining portion 71B formed on the counterpart side wall 71 on the X1 side. The one-end-side narrow-width retaining portion 71A and the one-end-side wide-width retaining portion 71B are formed in a groove shape pitted downward from the top surface of the counterpart side wall 71. The one-end-side wide-width retaining portion 71B is larger than the one-end-side narrow-width retaining portion 71A in the terminal arrangement direction, i.e., its width is wider. The one-end-side narrow-width retaining portion 71A accommodates, press-fits, and retains a part of the counterpart signal terminal 80. The one-end-side wide-width retaining portion 71B accommodates, press-fits, and retains a part of the counterpart ground terminal 90.

As shown in FIG. 1, the counterpart end wall 72 has a metal-part retaining portion 72A that retains the fixing metal part 100 on its upper part. The metal-part retaining portion 72A is formed in a groove shape extending in the vertical direction and penetrating the counterpart end wall 72 to press-fit and retain the fixing metal part 100.

The partition wall 73 and the insertion wall 74 are formed with a plurality of other-end-side narrow-width retaining portions 75 that attaches the counterpart signal terminal 80 and a plurality of other-end-side wide-width retaining portions 76 that attaches the counterpart ground terminal 90. FIG. 2 shows the other-end-side narrow-width retaining portion 75 formed on the X2 side and the other-end-side wide-width retaining portion 76 formed on the X1 side. The other-end-side narrow-width retaining portion 75 and the other-end-side wide-width retaining portion 76 have a groove shape extending in the vertical direction, pitted downward from the side surface of the upper part of the insertion wall 74, and penetrating the partition wall 73. The other-end-side wide-width retaining portion 76 is larger than the other-end-side narrow-width retaining portion 75 in the terminal arrangement direction, i.e., its width is wider. The other-end-side narrow-width retaining portion 75 accommodates, press-fits, and retains a part of the counterpart signal terminal 80, and supports the surface of the plate of that part (the surface at a right angle with respect to the connector width direction) by the inner surface of the groove. The other-end-side wide-width retaining portion 76 accommodates, press-fits, and retains a part of the counterpart ground terminal 90, and supports the surface of the plate of that part (the surface at a right angle with respect to the connector width direction) by the inner surface of the groove.

As shown in FIG. 2, the insertion wall 74 extends from the underside of the partition wall 73 to the lower part in the center region of the partition wall 73 in the connector width direction and extends across the terminal arranging range in the terminal arrangement direction. The insertion wall 74 has an island shape. The annular space surrounding the insertion wall 74 is the counterpart receiving portion 77. The side surface of the insertion wall 74 (the surface at a right angle with respect to the connector width direction) is formed with a plurality of narrow-width accommodating grooves 74A to accommodate a part of the counterpart signal terminal 80 and a plurality of wide-width accommodating grooves 74B to accommodate a part of the counterpart ground terminal 90. FIG. 2 shows the narrow-width accommodating groove 74A formed on the X2 side and the wide-width accommodating groove 74B formed on the X1 side. As shown in FIG. 2, the narrow-width accommodating groove 74A and the wide-width accommodating groove 74B are pitted downward from the side surface of the insertion wall 74 in the range except the upper part of the insertion wall 74 and extend in the vertical direction. The wide-width accommodating groove 74B is formed to have a groove width wider than that of the narrow-width accommodating groove 74A, i.e., its width is wider in the terminal arrangement direction. The narrow-width accommodating groove 74A communicates with the other-end-side narrow-width retaining portion 75, and the wide-width accommodating groove 74B communicates with the other-end-side wide-width retaining portion 76.

The counterpart terminals 80 and 90 are a so-called bent terminal formed by bending a metal band-shaped piece in the plate thickness direction. The counterpart terminals 80 and 90 are disposed such that the terminal width direction matches the terminal arrangement direction (Y-axis direction). As shown in FIG. 2, the counterpart terminals 80 and 90 are arranged in the terminal arrangement direction (Y-axis direction) so as to face each other in the connector width direction (X-axis direction) to form two counterpart terminal lines. In the counterpart terminal lines, the counterpart signal terminal 80 is disposed at the position corresponding to the signal terminal 40 of the connector 1, and the counterpart ground terminal 90 is disposed at the position corresponding to the ground terminal 50 of the connector 1. Therefore, on both sides of the counterpart signal terminal pair including the two counterpart signal terminals 80 adjacent to each other, the counterpart ground terminal 90 is disposed. Consequently, the suppression of crosstalk between the counterpart signal terminal pairs adjacent to each other is intended. In the connector width direction, the counterpart signal terminal 80 and the counterpart ground terminal 90 are disposed facing each other. Consequently, the suppression of crosstalk between the counterpart signal terminal 80 of the counterpart terminal line on the X1 side and the counterpart signal terminal 80 of the counterpart terminal line on the X2 side is intended.

As shown in FIG. 2 and FIGS. 7 to 10, the counterpart signal terminal 80 has a connecting portion 81 formed at one end portion located the upper part, a one-end-side retained portion 82 extending inwardly from the connecting portion 81 toward the connector width direction, a counterpart arm portion 83 formed on the other end portion located on the lower part from the connecting portion 81 and inwardly in the connector width direction, an other-end-side retained portion 84 extending upward from the counterpart arm portion 83, and an exposed portion 85 that couples the one-end-side retained portion 82 to the other-end-side retained portion 84.

As shown in FIG. 2, the connecting portion 81 extends in the connector width direction outward at a position at the top end of the counterpart side wall 71. The connecting portion 81 is structured so as to be solder-connected to the corresponding circuit part (e.g., a pad) on the mounting surface of the circuit board (not shown). The one-end-side retained portion 82 is bent in a crank shape at the inner end of the connecting portion 81 (the end portion on the inner side in the connector width direction) and extends inwardly toward the connector width direction. The one-end-side retained portion 82 is press-fitted into and retained in the one-end-side narrow-width retaining portion 71A of the counterpart housing 70.

As shown in FIG. 2, the counterpart arm portion 83 is disposed so as to extend along the narrow-width accommodating groove 74A of the counterpart housing 70 in the vertical direction to face the counterpart receiving portion 77. The counterpart arm portion 83 is elastically displaceable in the plate thickness direction, i.e., in the connector width direction. The counterpart arm portion 83 is contactable with the arm portion 43 of the signal terminal 40 of the connector 1 as the surface of the plate on the outer side in the connector width direction is the contact surface (see FIGS. 11 and 12).

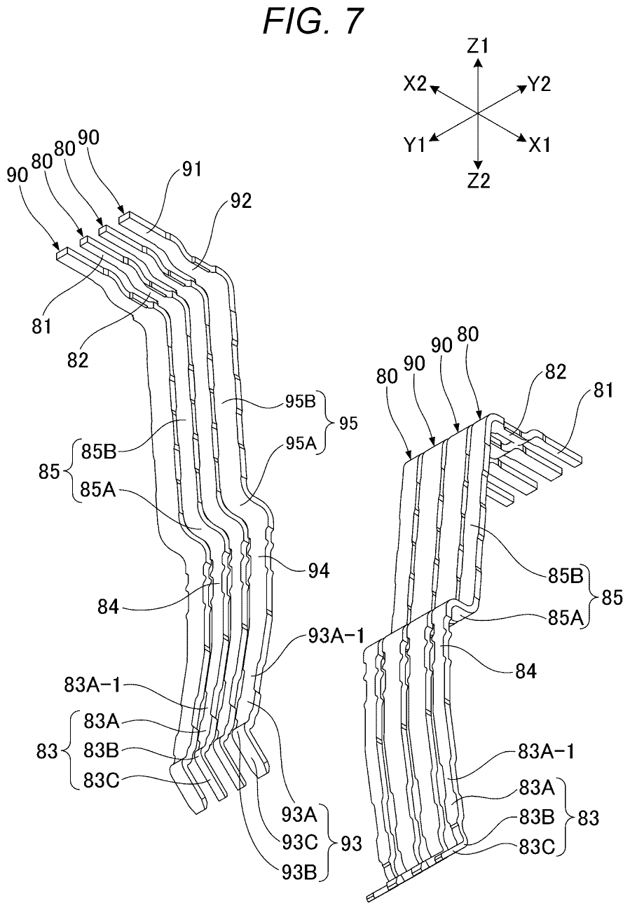

The counterpart arm portion 83 has the same shape as the arm portion 43 of the signal terminal 40. More specifically, the counterpart arm portion 83 has the first counterpart contacting portion 83A and a second counterpart contacting portion 83B that contacts the arm portion 43 and a counterpart guide portion 83C that guides the signal terminal 40. Specifically, the counterpart arm portion 83 linearly extends so as to be slightly inclined toward the connector width direction outward as the counterpart arm portion 83 moves to the lower part along the vertical direction. As shown in FIGS. 7, 9A, and 10A, in the first counterpart contacting portion 83A, a middle portion 83A-1 of the first counterpart contacting portion 83A in the vertical direction is formed to have a terminal width narrower than that of the other portions, i.e., its width is narrower.

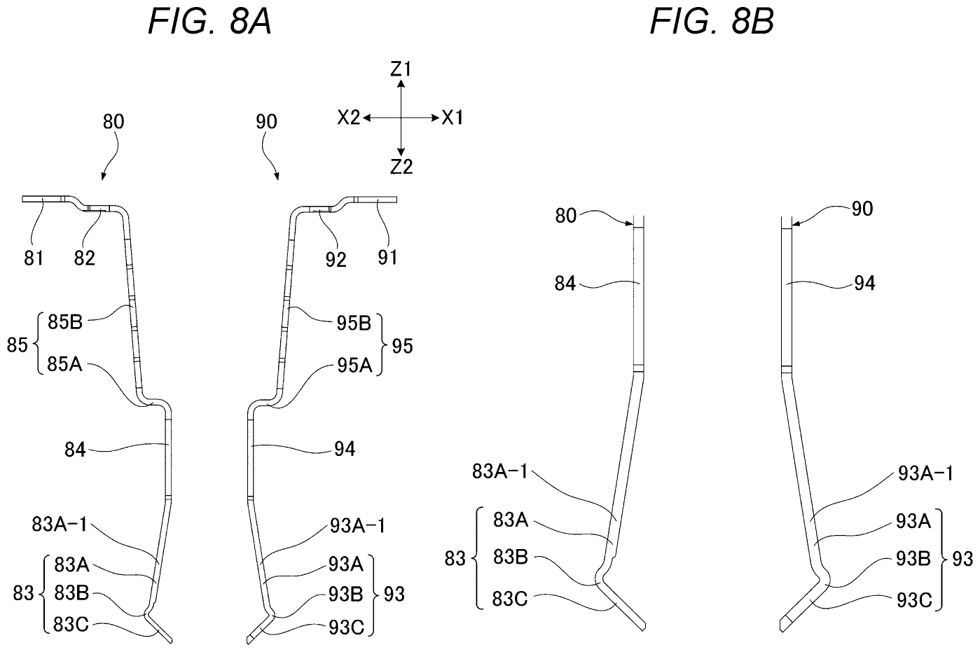

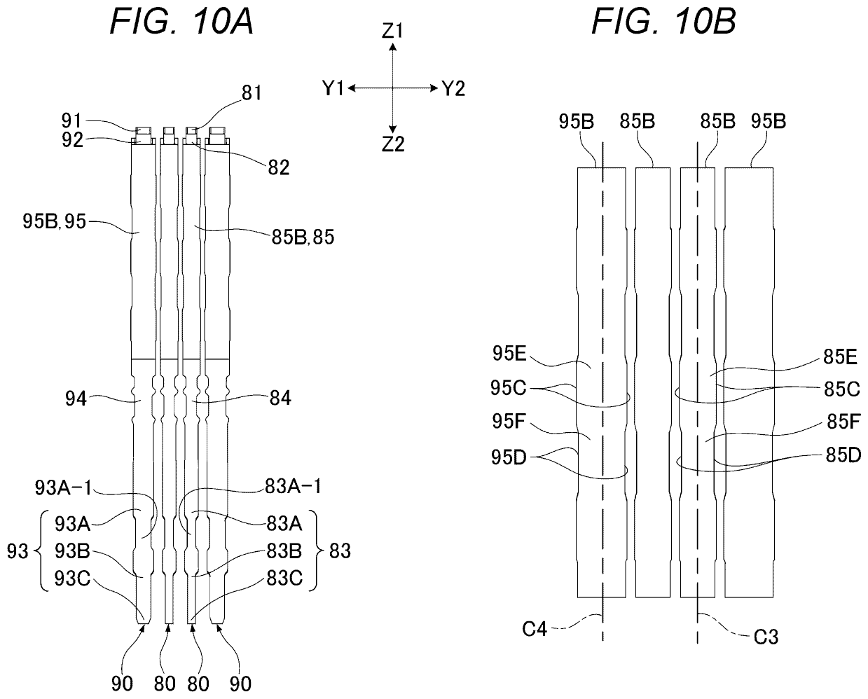

The second counterpart contacting portion 83B is bent so as to project in the connector width direction outward at the lower part from the first counterpart contacting portion 83A. The counterpart guide portion 83C extends so as to be inclined inwardly in the connector width direction as the counterpart guide portion 83C moves from the lower end of the second counterpart contacting portion 83B to the lower part. As shown in FIG. 10A, the second counterpart contacting portion 83B and the counterpart guide portion 83C are formed to have a terminal width slightly narrower than that of the middle portion 83A-1 of the first counterpart contacting portion 83A. The second counterpart contacting portion 83B and the counterpart guide portion 83C are crushed in the plate thickness direction. Consequently, as shown in FIGS. 8A and 8B, the second counterpart contacting portion 83B and the counterpart guide portion 83C are formed to have a plate thickness dimension smaller than the plate thickness dimension of the first counterpart contacting portion 83A. In other words, the second counterpart contacting portion 83B and the counterpart guide portion 83C are thinner than the first counterpart contacting portion 83A. In the present embodiment, the second counterpart contacting portion 83B and the counterpart guide portion 83C are formed to have a plate thickness dimension one-half or more and three-quarters or less of the plate thickness dimension of the first counterpart contacting portion 83A.

The second counterpart contacting portion 83B and the counterpart guide portion 83C are formed to have a plate thickness dimension smaller than the plate thickness dimension of the first contacting portion 43A of the signal terminal 40 (see FIG. 12). In other words, the second counterpart contacting portion 83B and the counterpart guide portion 83C are thinner than the first contacting portion 43A. In the present embodiment, the second counterpart contacting portion 83B and the counterpart guide portion 83C are formed to have a plate thickness dimension one-half or more and three-quarters or less of the plate thickness dimension of the first contacting portion 43A.

The plate thickness dimension of the second counterpart contacting portion 83B is one-half or more of the plate thickness dimension of the first counterpart contacting portion 83A and the first contacting portion 43A, and thus, it becomes easily secure the withstandable strength of the contact pressure of the second counterpart contacting portion 83B in contacting the first contacting portion 43A. The plate thickness dimension of the second counterpart contacting portion 83B is three-quarters or less of the plate thickness dimension of the first counterpart contacting portion 83A, and thus, it is possible to sufficiently reduce the cross-sectional area of the second counterpart contacting portion 83B at the contact position with the first contacting portion 43A. Consequently, a sudden change in the impedance is sufficiently easily suppressed at this contact position. The plate thickness dimension of the second counterpart contacting portion 83B is three-quarters or less of the plate thickness dimension of the first contacting portion 43A, i.e. the plate thickness dimension of the first contacting portion 43A is four-thirds or more of the plate thickness dimension of the second counterpart contacting portion 83B, and thus, it is possible to sufficiently thicken the first contacting portion 43A to the second counterpart contacting portion 83B. As a result, an excessive elastic displacement in the first contacting portion 43A is easily suppressed.

As shown in FIG. 2, the exposed portion 85 extends so as to be exposed from the counterpart housing 70 in the internal space 78 formed on the upper part of the partition wall 73 of the counterpart housing 70. The exposed portion 85 couples the inner end of the one-end-side retained portion 82 to the top end of the other-end-side retained portion 84. The exposed portion 85 has a horizontal portion 85A and a vertical portion 85B, and has an approximately L-shape when viewed from the terminal arrangement direction. The horizontal portion 85A is bent at a right angle at the top end of the other-end-side retained portion 84 and extends toward the connector width direction outward along the top surface of the partition wall 73. The vertical portion 85B linearly extends from the outer end of the horizontal portion 85A toward the upper part along the inner surface of the counterpart side wall 71. The vertical portion 85B is coupled to the inner end of the one-end-side retained portion 82. The vertical portion 85B is slightly inclined toward the connector width direction outward as the vertical portion 85B moves to the upper part.

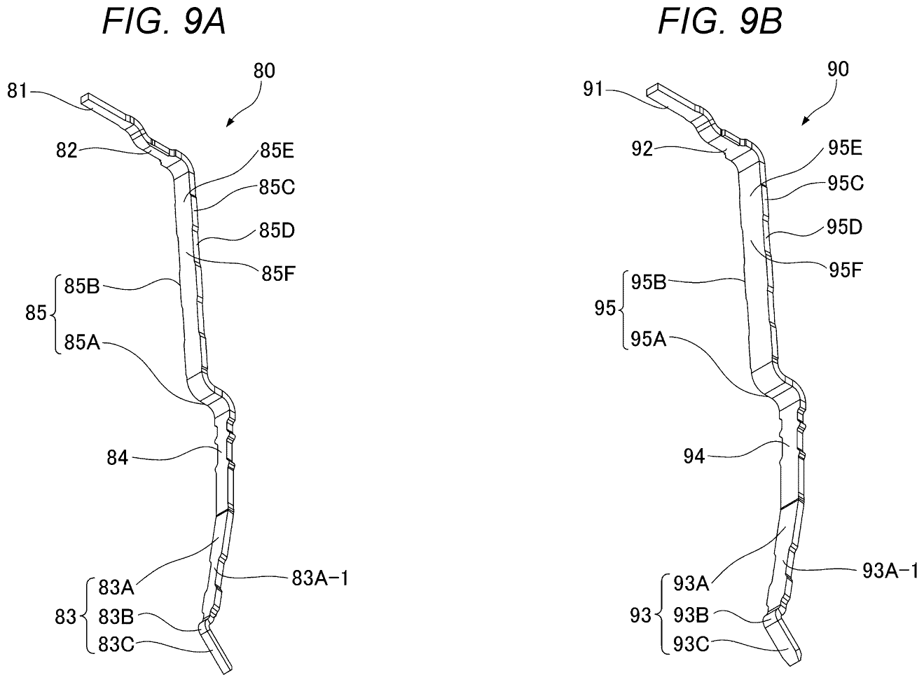

As shown in FIGS. 9A and 10B, in the exposed portion 85, a projection 85C and a recess 85D are alternately formed across the entire range on both side edges of the vertical portion 85B extending in the extending direction. In other words, the side edges of the vertical portion 85B include a plurality of the projections 85C and a plurality of the recesses 85D. The projections 85C and the recesses 85D on both side edges are at the same positions in the extending direction. In other words, the exposed portion 85 has a line symmetry shape with respect to the center line extending in the extending direction at the center position in the terminal width direction (Y-axis direction). FIG. 10B shows a state in which the vertical portion 85B of the exposed portion 45 has line symmetry with respect to the center line C3.

In the vertical portion 85B, a wide width portion 85E is formed in the range corresponding to the projection 85C in the extending direction, and a narrow width portion 85F having a terminal width narrower than that of the wide width portion 85E is formed in the range corresponding to the recess 85D in the extending direction. Both side edges of the wide width portion 85E and the narrow width portion 85F have a linear shape extending in the extending direction.

In the counterpart signal terminal pair, in the two vertical portions 85B adjacent to each other, the wide width portions 85E and the narrow width portions 85F are at the same positions in the extending direction. Therefore, the side edges of the wide width portion 85E facing each other are brought close to each other. As a result, it is possible to improve the electrical bond strength between the counterpart signal terminals 80 in the range of the wide width portion 85E. In the present embodiment, the space between the side edges of the wide width portion 85E is set to the plate thickness dimension or less of the exposed portion 85. The wide width portions 85E are brought close to each other in such a narrow space, and thus, it is possible to further improve the electrical bond strength between the counterpart signal terminal pair.

Since the exposed portion 85 is exposed in the air, the impedance of the exposed portion 85 is easily increased at this point. However, in the present embodiment, the wide width portion 85E with a wide terminal width is provided on the exposed portion 85, and thus, the impedance is easily reduced. As a result, it is possible to suppress an increase in the impedance of the exposed portion 85. In the counterpart signal terminal pair, the wide width portions 85E are brought close to each other, and thus, the electrical bond strength is improved, and the impedance is further reduced. In the present embodiment, in the exposed portion 85, the wide width portion 85E as well as the narrow width portion 85F are provided. In the range of the narrow width portion 85F, the terminal width is small, and the space between the facing side edges is larger than the space between the wide width portions 85E. As a result, the impedance easily increases in the range of the narrow width portion 85F. As described above, in the present embodiment, the exposed portion 45 is provided with the wide width portion 85E as well as the narrow width portion 85F.

Consequently, even though the side edges of the wide width portion 85E are brought close to each other, it is possible to relax the degree of deterioration in the impedance of the exposed portion 85 as a whole. Therefore, it is possible to excellently suppress an excessive deterioration in the impedance of the exposed portion 85.

The counterpart ground terminal 90 is disposed such that the terminal width direction matches the terminal arrangement direction (Y-axis direction). The counterpart ground terminal 90 has a shape where the counterpart signal terminal 80 is large in the terminal width direction, i.e., its width is wide.

As shown in FIG. 2 and FIGS. 7 to 10, the counterpart ground terminal 90 has a connecting portion 91 formed on one end portion located on the upper part, a one-end-side retained portion 92 extending inwardly from the connecting portion 91 toward the connector width direction, a counterpart arm portion 93 formed at the other end portion located on the lower part from the connecting portion 91 and inwardly in the connector width direction, an other-end-side retained portion 94 extending upward from the counterpart arm portion 93, and an exposed portion 95 that couples the one-end-side retained portion 92 to the other-end-side retained portion 94.

The counterpart ground terminal 90 has approximately the same shape as the counterpart signal terminal 80 when viewed from the terminal arrangement direction. However, the counterpart ground terminal 90 has a width wider than that of the counterpart signal terminal 80. The shape of the counterpart arm portion 93 is different from the shape of the counterpart arm portion 83 of the counterpart signal terminal 80.

The counterpart arm portion 93 has a first counterpart contacting portion 93A and a second counterpart contacting portion 93B that contact the arm portion 53 of the ground terminal 50 and a counterpart guide portion 93C that guides the arm portion 53. The first counterpart contacting portion 93A has the same shape as the first counterpart contacting portion 83A of the counterpart signal terminal 80 when viewed from the terminal width direction. As shown in FIGS. 7, 9B, and 10A, in the first counterpart contacting portion 93A, a middle portion 93A-1 in the vertical direction is formed to have a width narrower than that of the other portions. As shown in FIGS. 8A and 8B, the second counterpart contacting portion 93B and the counterpart guide portion 93C are not crushed and are formed to have the same plate thickness dimension as the first counterpart contacting portion 93A. At this point, the shapes of the second counterpart contacting portion 93B and the counterpart guide portion 93C are different from the shapes of the second counterpart contacting portion 83B and the counterpart guide portion 83C of the counterpart signal terminal 80. In other words, the counterpart arm portion 93 is formed to have the same plate thickness dimension across the entire length.

As shown in FIGS. 7, 8A, and 9B, the exposed portion 95 has a horizontal portion 95A and a vertical portion 95B. The exposed portion 95 has the same shape as the exposed portion 85 of the counterpart signal terminal 80 when viewed from the terminal width direction. As shown in FIGS. 9B and 10B, a projection 95C and a recess 95D are alternately formed on the exposed portion 95 across the entire range on both side edges of the vertical portion 95B extending in the extending direction. In other words, the side edges of the vertical portion 95B include a plurality of projections 95C and a plurality of recesses 95D. The projections 95C and the recesses 95D on both side edges are at the same positions in the extending direction. In other words, the exposed portion 95 has a line symmetry shape with respect to the center line C4 extending in the extending direction at the center position in the terminal width direction (Y-axis direction). FIG. 10B shows a state in which the vertical portion 95B of the exposed portion 95 has line symmetry with respect to the center line C4.

In the vertical portion 95B, a wide width portion 95E is formed in the range corresponding to the projection 95C in the extending direction, and a narrow width portion 95F having a terminal width narrower than that of the wide width portion 95E is formed in the range corresponding to the recess 95D in the extending direction. Both side edges of the wide width portion 95E and the narrow width portion 95F have a linear shape extending in the extending direction.

In the projection 95C and the recess 95D, the position located in the extending direction and the shape are the same as the projection 85C and the recess 85D of the counterpart signal terminal 80. In other words, the side edge of the vertical portion 95B of the counterpart ground terminal 90 has the same shape as the side edge of the vertical portion 85B of the counterpart signal terminal 80. Therefore, the wide width portion 95E and the side edges of the wide width portion 85E facing each other are brought close to each other. As a result, in the range of the wide width portion 95E and the wide width portion 85E, it is possible to improve the electrical bond strength between the counterpart ground terminal 90 and the counterpart signal terminal 80. In the present embodiment, the space between the side edges of the wide width portion 95E and the wide width portion 85E is set to the plate thickness dimension or less of the exposed portion 95 and the exposed portion 85. The wide width portion 95E and the wide width portion 85E are brought close to each other in such a narrow space, and thus, it is possible to further improve the electrical bond strength between the counterpart ground terminal 90 and the counterpart signal terminal 80.

As shown in FIG. 1, the fixing metal part 100 is formed by bending a metal plate member in the plate thickness direction. The fixing metal part 100 has a retained plate 101 press-fitted into and retained in the metal-part retaining portion 72A of the counterpart end wall 72 and a fixed leg 102 fixed to the circuit board. The retained plate 101 has a flat plate shape having the surface of a plate at a right angle with respect to the terminal arrangement direction. The retained plate 101 is press-fitted and retained in the metal-part retaining portion 72A by the side edge portion extending in the vertical direction. The fixed leg 102 has a plate shape bent at a right angle at the top end of the retained plate 101 and extending outward in the terminal arrangement direction. The fixed leg 102 is solder-connected and fixed to a corresponding part, such as a pad, formed on the mounting surface of the circuit board.

The counterpart connector 2 is manufactured by the following procedures. First, the manufacturing processes of the counterpart signal terminal 80 will be described. The counterpart signal terminal 80 is manufactured by processing a metal plate member having the same thickness as the metal plate member used for manufacturing the terminals 40 and 50. The counterpart signal terminal 80 is produced in such a manner that a metal plate member is cut to obtain a metal band-shaped piece, a part of the obtained metal band-shaped piece is crushed, and the metal band-shaped piece is bent in the plate thickness direction. More specifically, first, the surface of the plate of the metal plate member disposed on a cutting mold die (not shown) is held by a stripper (not shown). Subsequently, a part corresponding to one side-edge side of the counterpart signal terminal 80 in the metal plate member is cut with a punch (not shown) in the plate thickness direction (first cutting process). After that, a part corresponding to the other side-edge side of the metal plate member is also cut (second cutting process). As a result, the metal plate band-shaped piece is obtained. Subsequently, the parts corresponding to the second counterpart contacting portion 83B and the counterpart guide portion 83C in the metal band-shaped piece are crushed in the plate thickness direction. Subsequently, the metal band-shaped piece is bent in the plate thickness direction, and the counterpart signal terminal 80 is obtained.

The counterpart ground terminal 90 is manufactured by processing a metal plate member having the same thickness as the metal plate member used for manufacturing the terminals 40 and 50 and the counterpart signal terminal 80. Since the manufacturing processes of the counterpart ground terminal 90 are the same as the manufacturing processes of the counterpart signal terminal 80 except the point that crushing is not performed, the description is omitted.

In the present embodiment, the counterpart terminals 80 and 90 have the wide width portions 85E and 95E with a wide terminal width. As a result, in the second cutting process of the counterpart terminals 80 and 90, it is possible to largely secure the terminal width dimension, and thus, the area of the surface of the plate to be held by a stripper. Therefore, sharing deformation in the vertical portions 85B and 95B due to the cutting process is difficult to occur, and thus, it is possible to suppress the formation of the metal band-shaped piece in a twisted shape. Consequently, it is possible to easily produce the counterpart terminals 80 and 90 in a normal shape by bending the metal band-shaped piece.

In the present embodiment, the side edge of the vertical portion 85B of the counterpart signal terminal 80 and the side edge of the vertical portion 95B of the counterpart ground terminal 90 are in the same shape. Therefore, in both the manufacturing processes of the counterpart signal terminal 80 and the manufacturing processes of the counterpart ground terminal 90, it is possible to use the same cutting mold. As a result, it is possible to curtail manufacturing costs for the counterpart terminals 80 and 90.

Next, the assembly processes of the counterpart connector 2 will be described. First, the one-end-side retained portion 82 of the counterpart signal terminal 80 and the one-end-side retained portion 92 of the counterpart ground terminal 90 are press-fitted into the one-end-side narrow-width retaining portion 71A of the counterpart housing 70 and the one-end-side wide-width retaining portion 71B from above. Simultaneously with this, the other-end-side retained portion 84 of the counterpart signal terminal 80 and the other-end-side retained portion 94 of the counterpart ground terminal 90 are press-fitted into the other-end-side narrow-width retaining portion 75 and the other-end-side wide-width retaining portion 76 of the counterpart housing 70 from above. As a result, the counterpart terminals 80 and 90 are retained in the counterpart housing 70.

Subsequently, the retained plate 101 of the fixing metal part 100 is press-fitted into the metal-part retaining portion 72A of the counterpart housing 70 from below, and the fixing metal part 100 is retained in the counterpart housing 70. As described above, the counterpart terminals 80 and 90 and the fixing metal part 100 are attached to the counterpart housing 70, and thus, the counterpart connector 2 is completed. In addition, the fixing metal part 100 may be attached to the counterpart housing 70 prior to the counterpart terminals 80 and 90. The fixing metal part 100 may be attached to the counterpart housing 70 simultaneously with the counterpart terminals 80 and 90.

Next, the operation of fitting and connecting the connector 1 and the counterpart connector 2 will be described. First, the connector 1 is solder-connected to the mounting surface of the circuit board (not shown) for mounting, and the counterpart connector 2 is solder-connected to the other mounting surface of the circuit board (not shown) for mounting. Subsequently, as shown in FIGS. 1 and 2, the connector 1 is disposed on the upper part of the connector 1 in the attitude such that the receiving portion 35 is opened to the upper part, and the counterpart connector 2 is disposed in the attitude such that the counterpart receiving portion 77 is opened to the lower part. The counterpart connector 2 is then moved to the lower part, and the fitting and connection of the counterpart connector 2 to the connector 1 are started.

In the connector fitting process, the fitting portion 31 of the connector 1 enters the inside of the counterpart receiving portion 77 of the counterpart connector 2 from below. Simultaneously with this, the insertion wall 74 of the counterpart connector 2 enters the inside of the receiving portion 35 of the connector 1 from above. As a result, the counterpart guide portion 83C of the counterpart signal terminal 80 contacts the guide portion 43C of the signal terminal 40 to elastically displace the first contacting portion 43A in the connector width direction outward. Simultaneously with this, the counterpart guide portion 83C receives reaction force from the guide portion 43C, and the first counterpart contacting portion 83A is elastically displaced inwardly in the connector width direction. The counterpart guide portion 93C of the counterpart ground terminal 90 contacts the guide portion 53C of the ground terminal 50 to elastically displace the first contacting portion 53A in the connector width direction outward. Simultaneously with this, the counterpart guide portion 93C receives reaction force from the guide portion 53C, and the first counterpart contacting portion 93A is elastically displaced inwardly in the connector width direction.

As described above, the first contacting portions 43A and 53A of the arm portions 43 and 53 of and the first counterpart contacting portions 83A and 93A of the counterpart arm portions 83 and 93 are elastically displaced, and thus, the counterpart connector 2 is allowed to further move to the lower part. As shown in FIG. 11, the arm portions 43 and 53 are accommodated in the grooves 32A and 32B except the second contacting portions 43B and 53B. The counterpart arm portions 83 and 93 are accommodated in the grooves 74A and 74B except the second counterpart contacting portions 83B and 93B.

As shown in FIG. 11, when the connector fitting process proceeds and the fitting portion 31 of the connector 1 is fitted into the counterpart receiving portion 77 of the counterpart connector 2, the operation of fitting and connecting the connector is completed, and the connector 1 and the counterpart connector 2 are in a fitted and connected state. In the fitted and connected state, the elastic displacement state of the arm portions 43 and 53 of the terminals 40 and 50 and the counterpart arm portions 83 and 93 of the counterpart terminals 80 and 90 is maintained, the arm portion 43 and the counterpart arm portion 83 contact each other with a contact pressure, and the arm portion 53 and the counterpart arm portion 93 contact each other with a contact pressure. More specifically, as shown in FIG. 12, the second contacting portion 43B contacts the middle portion 83A-1 of the first counterpart contacting portion 83A, and the second contacting portion 53B contacts the middle portion 93A-1 of the first counterpart contacting portion 93A. The second counterpart contacting portion 83B contacts the middle portion 43A-1 of the first contacting portion 43A, and the second counterpart contacting portion 93B contacts the middle portion 53A-1 of the first contacting portion 53A. As described above, the arm portions 43 and 53 contact the counterpart arm portions 83 and 93, and thus, the terminals 40 and 50 electrically conduct the counterpart terminals 80 and 90.

In the present embodiment, the first contacting portions 43A and 53A and the first counterpart contacting portions 83A and 93A are elastically displaceable in the plate thickness direction. Therefore, the first contacting portions 43A and 53A and the first counterpart contacting portions 83A and 93A can contact the second counterpart contacting portions 83B and 93B and the second contacting portions 43B and 53B in the state of being elastically displaced. As a result, as compared with the structure in which the first contacting portion and the first counterpart contacting portion are not elastically displaced, it is possible to excellently suppress the occurrence of weakening of the first contacting portions 43A and 53A and the first counterpart contacting portions 83A and 93A.

Immediately before the fitting state and in the fitted and connected state of the connectors 1 and 2, the fitting position of the connector 1 and the counterpart connector 2 is not always at a normal position in the terminal arrangement direction and in the connector width direction, and a displacement sometimes occurs in these directions. In the present embodiment, the displacement between the connectors 1 and 2 is absorbed by the movement of the movable housing 30 in the displacement direction due to the elastic displacement of the exposed portions 45 and 55 of the terminals 40 and 50, a so-called floating.

In the present embodiment, as shown in FIG. 6B, the third elastic portions 45C and 55C of the terminals 40 and 50 have a line symmetry shape with respect to the center lines C1 and C2. Therefore, the bias is difficult to occur in the elastic displacement in the terminal width direction, i.e., the elastic displacement toward one side in the terminal arrangement direction and the displacement toward the other side. In other words, the third elastic portions 45C and 55C are allowed to be equally elastically displaced to both sides. As a result, it is possible to obtain an excellent floating of the movable housing 30 in the terminal arrangement direction.

When the movable housing 30 floats in the terminal arrangement direction, the third elastic portions 45C and 55C of the terminals 40 and 50 are elastically displaced so as to be inclined toward the terminal arrangement direction. In the present embodiment, both side edges of the wide width portions 45F and 55F and both side edges of the narrow width portions 45G and 55G are in a linear shape. As a result, it is possible to almost constantly maintain the space between the side edges of the third elastic portions 45C and 55C adjacent to each other before and after the elastic displacement of the third elastic portions 45C and 55C. Therefore, it is possible to excellently suppress the contact of the side edges of the third elastic portions 45C and 55C adjacent to each other when the third elastic portions 45C and 55C are elastically displaced.

In the present embodiment, in the signal terminal 40, the second contacting portion 43B is formed thinner than the first contacting portion 43A. Therefore, at the contact position of the second contacting portion 43B with the first counterpart contacting portion 83A of the counterpart signal terminal 80, the cross-sectional area of the signal transmission path, i.e., the total of the cross-sectional area of the second contacting portion 43B and the cross-sectional area of the first counterpart contacting portion 83A is smaller than the case in which the second contacting portion 43B is not thinner than the first contacting portion 43A. As a result, in the signal transmission path, a sudden change in the cross-sectional area is suppressed at the contact position of the second contacting portion 43B with the first counterpart contacting portion 83A. Consequently, a sudden change in the impedance at this contact position is suppressed.

In the counterpart signal terminal 80, the second counterpart contacting portion 83B is formed thinner than the first counterpart contacting portion 83A. Therefore, the cross-sectional area of the signal transmission path, i.e., the total of the cross-sectional area of the second counterpart contacting portion 83B and the cross-sectional area of the first contacting portion 43A at the contact position of the second counterpart contacting portion 83B with the first contacting portion 43A of the signal terminal 40 is smaller than the case in which the second counterpart contacting portion 83B is not thinner than the first counterpart contacting portion 83A. As a result, in the signal transmission path, a sudden change in the cross-sectional area is suppressed at the contact position of the second counterpart contacting portion 83B with the first contacting portion 43A. Consequently, a sudden change in the impedance is suppressed at this contact position.

The second contacting portion 43B is thinner than the first contacting portion 43A as well as the second counterpart contacting portion 83B is thinner than the first counterpart contacting portion 83A, and thus, it is possible to suppress a sudden change in the impedance at the contact position of the signal terminal 40 with the counterpart signal terminal 80. As a result, it is unnecessary to thin the second contacting portion 43B and the second counterpart contacting portion 83B as previously existing techniques, i.e., to reduce the width dimension of these terminals. Therefore, it is possible to sufficiently, largely secure the terminal width dimension for contacting the first counterpart contacting portion 83A with the first contacting portion 43A in the second contacting portion 43B and the second counterpart contacting portion 83B. As a result, even in the case in which the fitted and connected state of the connectors, the relative position of the signal terminal 40 to the counterpart signal terminal 80 in the terminal width direction is displaced, an excellent contact state of the signal terminal 40 with the counterpart signal terminal 80 is easily secured.

In the present embodiment, the first counterpart contacting portions 83A and 93A of the counterpart terminals 80 and 90 are formed thicker than the second contacting portions 43B and 53B of the terminals 40 and 50, and this resists an excessive elastic displacement. Therefore, it is possible to excellently suppress causing the second counterpart contacting portions 83B and 93B to separate from the first contacting portions 43A and 53A to be in a non-contact state in association with an excessive elastic displacement in the first counterpart contacting portions 83A and 93A. The first contacting portions 43A and 53A of the terminals 40 and 50 are formed thicker than the second counterpart contacting portions 83B and 93B of the counterpart terminals 80 and 90, and this resists an excessive elastic displacement. Therefore, it is possible to excellently suppress causing the second contacting portions 43B and 53B to separate from the first counterpart contacting portions 83A and 93A to be in a non-contact state in association with an excessive elastic displacement in the first contacting portions 43A and 53A. In the present embodiment, the arm portions 43 and 53 of the terminals 40 and 50

and the counterpart arm portions 83 and 93 of the counterpart terminals 80 and 90 have the same shape. Therefore, it is possible to equalize the contact pressure when the second contacting portions 43B and 53B of the arm portions 43 and 53 contacts the first counterpart contacting portions 83A and 93A of the counterpart arm portions 83 and 93 and the contact pressure when the second counterpart contacting portions 83B and 93B of the counterpart arm portions 83 and 93 contacts the first contacting portions 43A and 53A of the arm portions 43 and 53. Consequently, it is possible to excellently reduce the bias of the attitude of the arm portions 43 and 53 and the counterpart arm portions 83 and 93 in the elastic displacement state.

In the present embodiment, in the arm portion 43 of the signal terminal 40, the second contacting portion 43B is formed thinner than the first contacting portion 43A. In the counterpart arm portion 83 of the counterpart signal terminal 80, the second counterpart contacting portion 83B is formed thinner than the first counterpart contacting portion 83A.

As described above, the second contacting portion 43B and the second counterpart contacting portion 83B is formed thinner without thinning the first contacting portion 43A and the first counterpart contacting portion 83A, and thus, it is possible to excellently suppress a sudden change in the impedance at the contact position of the signal terminal 40 with the counterpart signal terminal 80.

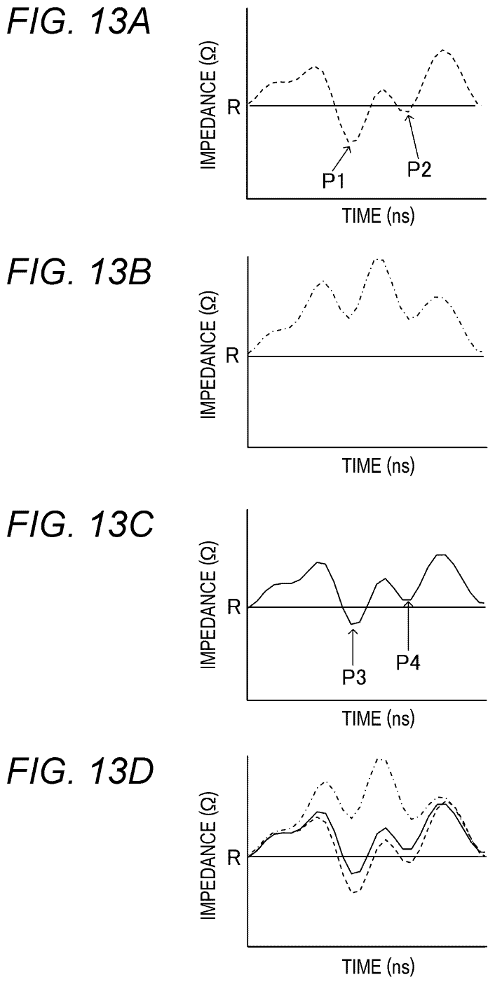

FIGS. 13A to 13D are graphs showing the measurement result of the impedance in the case in which signals are transmitted using terminals and counterpart terminals in three types of shapes with different thicknesses of the arm portion and the counterpart arm portion. More specifically, FIG. 13A is a graph of the measurement result of the terminal and the counterpart terminal, where the entire arm portion and the entire counterpart arm portion are formed thicker, and the measurement result is depicted by a broken line. FIG. 13B is a graph of the measurement result of the terminal and the counterpart terminal, where the entire arm portion and the entire counterpart arm portion are formed thinner, and the measurement result is depicted by an alternate long and short dashed line. FIG. 13C is a graph of the measurement result of the signal terminal 40 and the counterpart signal terminal 80 in the shape of the present embodiment, i.e., the second contacting portion 43B and the guide portion 43C of the arm portion 43 and the second counterpart contacting portion 83B and the counterpart guide portion 83C of the counterpart arm portion 83 are formed thinner, and the measurement result is depicted by a solid line. FIG. 13D is a graph showing the measurement results of FIGS. 13A to 13C are overlaid. In FIGS. 13A to 13D, the horizontal axis expresses time (ns), and the vertical axis expresses the impedance ((2). In FIGS. 13A to 13D, the value of the impedance to be a reference is shown as “R”.

In the case in which the entire arm portion and the entire counterpart arm portion are formed in a thick shape, as shown in FIG. 13A, the value of the impedance at lower peaks P1 and P2 greatly drops from the reference impedance R. In other words, at the lower peaks P1 and P2, the impedance is excessively reduced. In the case in which the entire arm portion and the entire counterpart arm portion are formed in a thin shape, as shown in FIG. 13B, the value of the impedance always exceeds the reference impedance R. In other words, the impedance is always excessively high.

In the present embodiment, as shown in FIG. 13C, the values of lower peaks P3 and P4 are higher than the values of the lower peaks P1 and P2 in FIG. 13A. In other words, at the lower peaks P3 and P4, an excessive deterioration in the impedance is suppressed. In the present embodiment, as shown in FIG. 13C, the value of the impedance is up and down in a range close to the reference impedance R as a whole, and the value is not excessively increased. These results are apparent from FIG. 13D showing the measurement results overlaid. As described above, according to the present embodiment, as compared with the case in which the entire arm portion and the entire counterpart arm portion are formed in a thick shape and the case in which the entire arm portion and the entire counterpart arm portion are formed in a thin shape, it is possible to bring the value of the impedance close to the reference impedance R.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An electrical connector comprising:
a plurality of signal terminals having a shape where a metal plate member is bent in a plate thickness direction, and arranged as one direction parallel to a surface of a plate is an arrangement direction; and
a housing that retains the plurality of signal terminals, wherein
a direction at a right angle with respect to the arrangement direction is a fitting direction that is a direction of fitting and connecting a counterpart connector, the plurality of signal terminals includes a signal terminal pair having a pair of signal terminals adjacent to each other, and a differential signal is transmissible by the signal terminal pair,
the signal terminals of the signal terminal pair have an exposed portion exposed and extending from the housing,
the exposed portion has a projection and a recess formed on both side edges of the exposed portion extending in an extending direction, a wide width portion formed in a range corresponding to the projection, and a narrow width portion formed in a range corresponding to the recess, the narrow width portion having a terminal width narrower than that of the wide width portion, and
the wide width portions and the narrow width portions of the exposed portion in the signal terminal pair are formed at same positions in the extending direction.

2. The electrical connector according to claim 1, wherein
the housing has a fixing housing and a movable housing relatively movable with respect to the fixing housing,
the signal terminal is provided so as to be provided over the fixing housing and the movable housing,
the exposed portion is located between the fixing housing and the movable housing, and the exposed portion permits relative movement of the movable housing by elastic displacement, and
the exposed portions of the signal terminals have a line symmetry shape with respect to a center line extending in the extending direction at a center position of a terminal width in the arrangement direction.

3. The electrical connector according to claim 2, wherein
both side edges of the narrow width portion and both side edges of the wide width portion have a linear shape extending in the extending direction.

4. The electrical connector according to claim 1,
the pair of signal terminals is disposed at a position where a space between the wide width portions is a plate thickness dimension of the signal terminal or less.

5. The electrical connector according to claim 2,
the pair of signal terminals is disposed at a position where a space between the wide width portions is a plate thickness dimension of the signal terminal or less.

6. The electrical connector according to claim 3,
the pair of signal terminals is disposed at a position where a space between the wide width portions is a plate thickness dimension of the signal terminal or less.
